(19) United States
(12) Patent Application Publication
(10) Pub. No.: US 2016/0286905 A1
(43) Pub. Date: Oct. 6, 2016

(54) ARTICLE OF FOOTWEAR HAVING GROUND SURFACE MATERIAL ACCUMULATION PREVENTION STRUCTURE

(71) Applicant: NIKE, Inc., Beaverton, OR (US)

(72) Inventor: Denis Schiller, Vancouver, WA (US)

(73) Assignee: NIKE, Inc., Beaverton, OR (US)

(21) Appl. No.: 15/036,546

(22) PCT Filed: Nov. 13, 2014
(86) PCT No.: PCT/US2014/065394

§ 371 Date: May 13, 2016

Related U.S. Application Data
(60) Provisional application No. 61/905,007, filed on Nov. 15, 2013.

(51) Int. Cl. A43C 15/02; B29D 35/14; A43B 13/12; A43B 13/18; A43C 15/16

(52) U.S. Cl. CPC A43C 15/02; A43B 13/182; A43B 13/183; A43C 15/161; A43B 13/122; B29D 35/142; B29K 2075/00

(57) ABSTRACT

An article of footwear includes a sole having a lower surface, a web that covers a portion of the lower surface of the sole, the web having an exposed surface, and a spring element disposed between the lower surface of the sole and the web. The spring element is configured to transition the exposed surface of the web between a first state and a second state in response to a compression force applied to the spring element by an external ground surface in a user activity, to prevent accumulation of ground surface material, such as mud, dirt, clay, sand, slush, etc., compacting on the sole of the article of footwear in the user activity.

### FIELD

The present invention relates generally to an article of footwear and, more particularly, to a sports shoe with cleats.

### BACKGROUND

An article of footwear may be used on many alternative types of ground surfaces. An article of footwear having at least one ground surface traction element may be used to provide traction on certain types of ground surface. In each case, use of an article of footwear in some types of ground surfaces, e.g., mud or slush, may result in accumulation of compacted ground surface material on the lower surface of the article of footwear. Accumulation of ground surface material on the lower surface of an article of footwear may reduce traction of the article of footwear and/or adversely affect performance characteristics of the article of footwear and the user.

### BRIEF DESCRIPTION OF THE DRAWINGS

The invention may be better understood with reference to the following drawings and description. Components in the figures are not necessarily to scale, emphasis instead being placed upon illustrating principles of the invention. In the figures, like reference numerals designate corresponding parts throughout the different views, with the initial digit(s) of each reference number indicating the figure in which the feature is first shown.

FIG. 1 is a perspective view of an embodiment of an article of footwear including ground surface material accumulation prevention structure according to the present invention.

FIG. 2 is a side profile view of the article of footwear of FIG. 1.

FIG. 3 is a plan view of a lower surface of the article of footwear of FIG. 1.

FIG. 4 is an exploded perspective view of an embodiment of the article of footwear of FIGS. 1-3, illustrating a first embodiment of ground surface material accumulation prevention structure according to the present invention.

FIG. 5 is a cross-sectional view of an embodiment of the ground surface material accumulation prevention structure of FIG. 4 taken along section line 5-5 of FIG. 3.

FIG. 6 is a perspective view of an embodiment of a spring element of the ground surface material accumulation prevention structure of FIG. 5.

FIG. 7 is a top plan view of the spring element of FIG. 6.

FIG. 8 is a perspective view of an embodiment of an article of footwear including a second embodiment of ground surface material accumulation prevention structure according to the present invention.

FIG. 9 is a side profile view of the article of footwear of FIG. 8.

FIG. 10 is a plan view of a lower surface of the article of footwear of FIG. 8.

FIG. 11 is an exploded perspective view of an embodiment of the article of footwear of FIGS. 8-10, illustrating a second embodiment of ground surface material accumulation prevention structure according to the present invention.

FIG. 12 is a cross-sectional view of an embodiment of the ground surface material accumulation prevention structure of FIGS. 8-10 taken along section line 12-12 of FIG. 10.

FIG. 13 is a perspective view of an embodiment of a spring element of the ground surface material accumulation prevention structure of FIG. 12.

FIG. 14 is a top plan view of the spring element of FIG. 13.

FIG. 15 is a partial perspective side profile view of an embodiment of a lower surface of the sole of the article of footwear illustrating the ground surface material accumulation prevention structure of the article of footwear of FIGS. 8-10.

FIG. 16 is a schematic cross-sectional view of an embodiment of the ground surface material accumulation prevention structure of FIG. 15.

FIG. 17 is a schematic cross-section view of an alternative embodiment of the ground surface accumulation prevention structure of FIG. 15, including plural spring elements.

FIG. 18 is a cross-sectional view of an alternative embodiment of ground surface material accumulation prevention structure.

FIG. 19 is a cross-sectional view of an alternative embodiment of ground surface material accumulation prevention structure.

FIG. 20 is an exploded view of an embodiment of a molding system for making a sole plate having ground surface material accumulation prevention structure including plural spring elements (open state).

FIG. 21 is an exploded view of an alternative embodiment of the molding system of FIG. 20 (open state) using plural sheets of mold material.

FIG. 22 is an exploded view of a second embodiment of a molding system for making a sole plate having ground surface material accumulation prevention structure (open state) including a serpentine spring element having plural spring elements.

FIG. 23 is an exploded view of an alternative embodiment of the molding system of FIG. 22 (open state) using plural sheets of mold material.

FIG. 24 is a schematic snap-shot profile view of an athlete, illustrating operation of an embodiment of an article of footwear including ground surface material accumulation prevention structure of the present invention.

FIG. 25 is a schematic sectional view illustrating the ground surface material accumulation prevention structure in a pre-surface strike state of the stride cycle.

FIG. 26 is a schematic sectional view illustrating the ground surface material accumulation prevention structure in an initial surface strike state of the stride cycle.

FIG. 27 is a schematic sectional view illustrating the ground surface material accumulation prevention structure in a partial ground penetration state of the stride cycle.

FIG. 28 is a schematic sectional view illustrating the ground surface material accumulation prevention structure in a full ground penetration/compression state of the stride cycle.

FIG. 29 is a schematic sectional view illustrating the ground surface material accumulation prevention structure in a partial release state of the stride cycle.

FIG. 30 is a schematic sectional view illustrating the ground surface material accumulation prevention structure in a substantial release state of the stride cycle.

FIG. 31 is a schematic sectional view illustrating the ground surface material accumulation prevention structure in a full release state of the stride cycle.

### DETAILED DESCRIPTION

In one aspect, an article of footwear may comprise a sole, a web, and a spring. The sole may have a lower surface. The web may cover at least a portion of the lower surface of the sole and may have an exposed surface. The spring may be disposed between the lower surface of the sole and the web. The spring may be configured to transition a portion of the exposed surface of the web between a first state and a second state in response to a compression force generated between the spring and an external ground surface by user activity, to prevent accumulation of ground surface material compacting on the sole of the article of footwear by the user activity.

In some embodiments, the spring may be configured to move the portion of the exposed surface of the web to a first position adjacent the lower surface of the sole in response to the compression force and to a second position located further from the lower surface of the sole than the first position in response to release of the compression force.

In some embodiments, the lower surface of the sole may include a first ground surface traction element and a second ground surface traction element. In some embodiments, the spring may be disposed between the first ground surface traction element and the second ground surface element. The spring may be optionally fixed to the lower surface of the sole.

In some embodiments, the spring may be a coil spring or a leaf spring.

In some embodiments, the web may be made of an elastomeric material.

In some embodiments, the web may include a wear resistant surface treated on at least one of (a) a portion of the web that contacts the spring and (b) a portion of the exposed surface of the web corresponding to a location of the spring.

In some embodiments, a perimeter portion of the web is fixed to the sole.

In some embodiments, a perimeter portion of the web may be bonded to the sole.

In some embodiments, a perimeter portion of the web may be molded to the sole.

In some embodiments, the article of footwear may include an upper, and a perimeter portion of the web may be fixed to the upper. In some embodiments, the perimeter portion of the web may be optionally fixed to the upper at a perimeter of the sole.

In some embodiments, a contour of the web may conform to a contour of the lower surface of the sole and the contour of the web may be pre-formed by molding.

In some embodiments, the spring may include a first spring disposed between a first cluster of ground surface traction elements and the article of footwear may include a second spring disposed between a second cluster of ground surface traction elements. The first spring may have a first spring constant k1, and the second spring constant may have a second spring constant k2. The first spring constant k1 may be optionally different from the second spring constant k2.

In some embodiments, the spring may be a leaf spring having a first spring element disposed between a first cluster of ground surface traction elements and a second spring element disposed between a second cluster of ground surface traction elements. The first spring element may have a first spring constant k1, and the second spring element may have a second spring constant k2.

In some embodiments, a contour of the web may conform to a contour of at least one of ground surface traction elements of the first cluster or the second cluster.

In some embodiments, the article of footwear may include a clip configured to attach to the at least one ground surface traction element with the web disposed between the clip and the at least one ground surface traction element. The clip may optionally form a band configured to conform to a perimeter surface portion of the at least one ground surface traction element.

In some embodiments, the spring may include a first spring disposed between a first cluster of ground surface traction elements and the article of footwear may include a second spring disposed between a second cluster of ground surface traction elements. The first spring may have a first size, and the second spring may have a second size different from the first size.

In one aspect, a method of making an article of footwear may include a step of providing a sole having a lower surface. The method may further include a step of providing a web that covers a portion of the lower surface of the sole, the web having an exposed surface. The method may further include a step of placing a spring between the lower surface of the sole and the web. The spring may be configured to transition a portion of the exposed surface of the web between a first state and a second state in response to a compression force generated between the spring and an external ground surface by user activity, to prevent accumulation of ground surface material compacting on the sole of the article of footwear by the user activity.

In some embodiments, the method may include providing a molding system. The molding system may include a first mold plate including a first mold cavity and a second mold plate including a second mold cavity. The method may include a step of placing a mold material blank in between the first mold plate and the second mold plate in a position adjacent to the first mold cavity. The method may further include a step of placing the sole plate in between the mold material blank and the second mold plate such that the sole plate is disposed within the second mold cavity. The method may include a step of positioning the spring element. The method may include a step of pressing the first mold plate and the second mold plate together. The method may include a step of applying heat to both the first mold plate and the second mold plate to mold the mold material blank to the lower surface of the sole plate such that the spring element is disposed between the mold material blank and the lower surface of the sole plate.

In some embodiments, the method may include a step of suctioning air from both the first mold cavity and the second mold cavity.

In some embodiments, the method may include a step of forming the mold material blank by cutting a sheet of mold material to have a perimeter that conforms with a perimeter of the sole plate.

Other systems, methods, features and advantages of the invention will be, or will become, apparent to one of ordinary skill in the art upon examination of the following figures and detailed description. It is intended that all such additional systems, methods, features and advantages be included within this description and this summary, and within the scope of the invention, and be protected by the following claims.

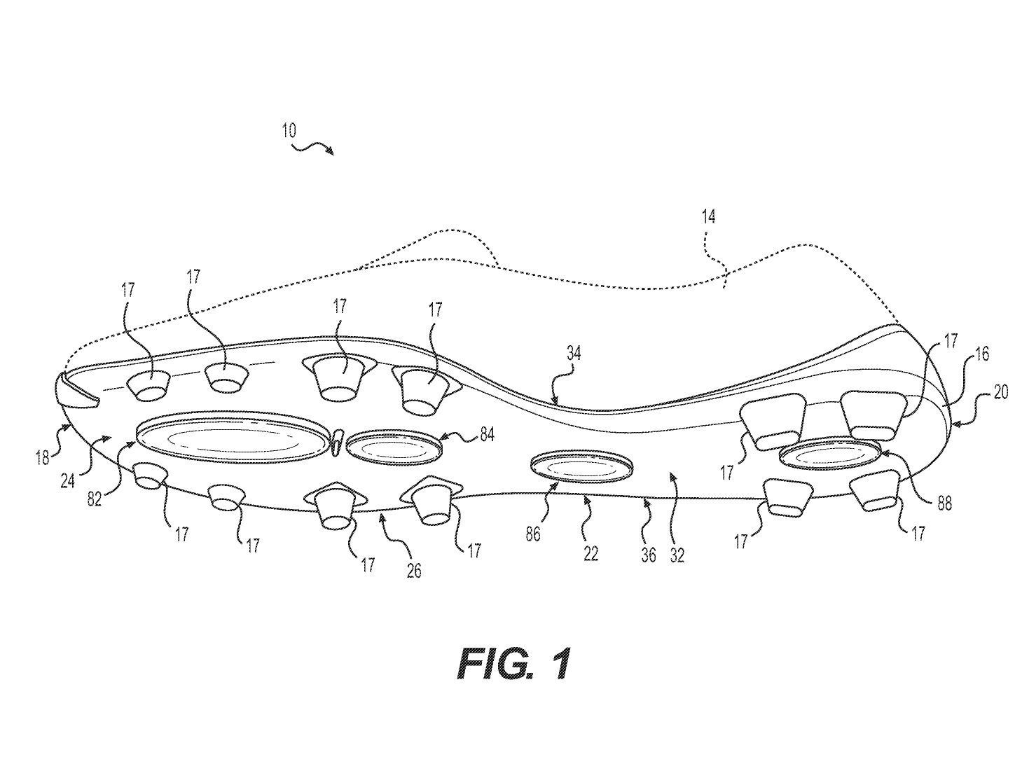

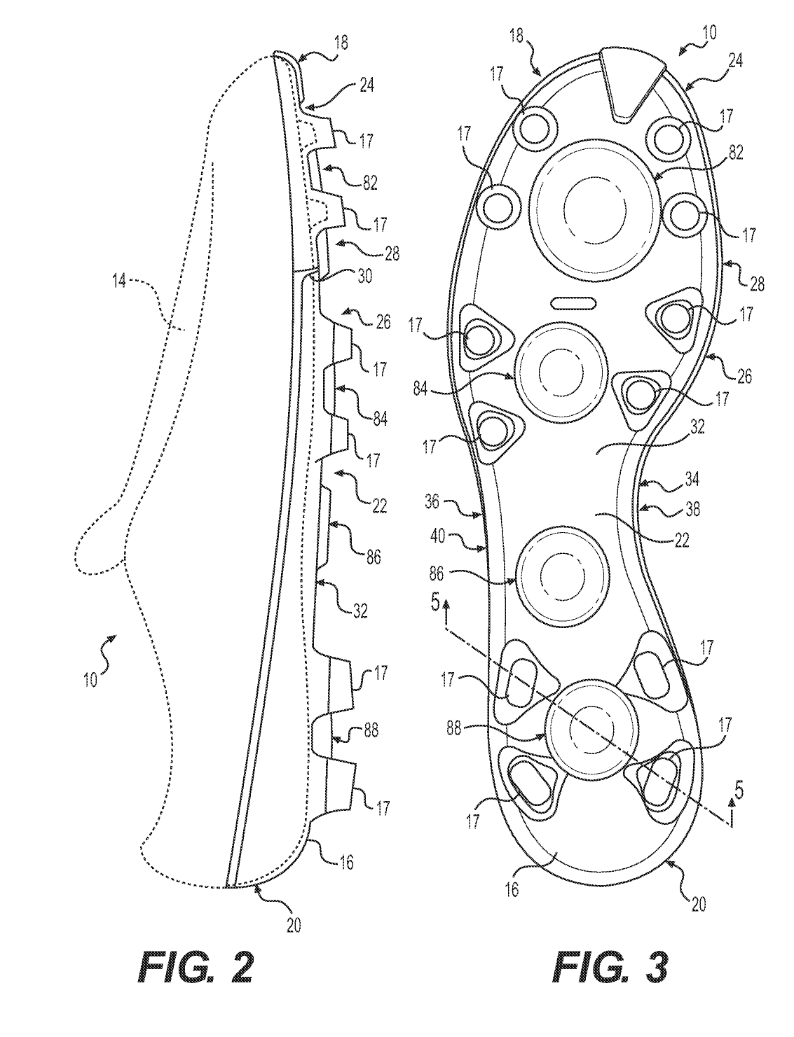

FIGS. 1-3 illustrate an embodiment of an article of footwear including ground surface material accumulation prevention structure according to the present invention. FIG. 1 is a perspective view of an article of footwear 10 including ground surface material accumulation prevention structures according to the present invention. For example, the article of footwear 10 may include a first ground surface material accumulation prevention structure 82, a second ground surface material accumulation prevention structure 84, a third ground surface material accumulation prevention structure 86, and a fourth ground surface material accumulation prevention structure 88. FIG. 2 is a side profile view of the article of footwear of FIG. 1. FIG. 3 is a plan view of a lower surface of a sole or sole plate of the article of footwear of FIG. 1. FIGS. 1-3 illustrate an exemplary configuration of the article of footwear 10 and ground surface material accumulation prevention structures. Those skilled in the art readily will appreciate alternative embodiments in view of the present disclosure.

Generally, the term “sole”, “sole plate”, or “cleated sole plate” as used in this detailed description and throughout the claims includes an element configured to be disposed as an outsole for an article of footwear that may include one or more ground surface traction elements, such as cleats. A sole may take the form of an outsole or a sole structure for any article of footwear including, but not limited to: soccer shoes, baseball shoes, hiking boots, football shoes, sneakers, rugby shoes, basketball shoes, track shoes, snow shoes, as well as other kids of shoes. In an exemplary embodiment, a sole may comprise essentially an entirety of an outsole of an article of footwear. In other embodiments, a sole may comprise a portion of an outsole of an article of footwear, including but not limited to one or more of a forefoot region, a midfoot region, and/or a heel region. In other embodiments, different configurations of a sole may be included in an article of footwear. For purposes of illustration, in various embodiments herein a sole is shown in isolation. In other embodiments, however, the sole could be associated with an upper for an article of footwear.

As shown in FIGS. 1-3, article of footwear 10 may include an upper 14 (shown in phantom by dashed lines) and a sole or sole plate 16. Upper 14 may be any known or later developed upper structure or design. Those skilled in the art readily will be able to select a structure and design for the upper 14 suitable for a desired type of article of footwear 10 and intended use.

Sole or sole plate 16 may be any known or later developed sole structure and design suitable for a desired article of footwear 10 having ground surface material accumulation prevention structures. Sole 16 may include one or more layers, including inner sole and/or midsole structures, made of known or later developed material(s) suitable for a desired use or activity. Sole 16 may include ground surface traction elements 17 suitable for an intended use or activity of the article of footwear 10. In some embodiments the ground surface traction elements 17 may include fixed or removable cleats or studs. In some embodiments a ground surface traction element 17 may locate, support, and/or secure a portion or element of at least one ground surface material accumulation prevention structure relative to the sole 16 of the article of footwear 10. Those skilled in the art readily will be able to select a structure, design, and material(s) for the sole 16, including a number and configuration of ground surface traction elements 17, suitable for a desired type of article of footwear 10 and intended use.

Article of footwear 10 may include a forefoot region 18 (distal end), a heel region 20 (proximal end) opposite forefoot region 18, and a midfoot region 22 disposed between forefoot region 18 and heel region 20. Forefoot region 18 may include a toe region 24 (most distal end) and a ball of foot region 26 disposed adjacent the toe region 24. Forefoot region 18 may include a flex region 28 located between the toe region 24 and the ball of foot region 26 that facilitates flexion of the user's toes relative to the foot in active use of the article of footwear 10. As shown in FIG. 2, in some embodiments the flex region 28 may include a sipe 30 formed in the sole 16, e.g., in a lower surface 32 of the article of footwear 10 and extending in a medial/lateral direction, to facilitate flexion. Midfoot region 22 may be located between the forefoot region 18 and the heel region 20, and may include a shank and/or arch region of the article of footwear 10.

Article of footwear 10 may include a medial portion 34 and a lateral portion 36. Medial portion 34 may include a medial side of the article of footwear 10, including a medial edge 38. Lateral portion 36 may include a lateral side of the article of footwear 10, including a lateral edge 40. Medial portion 34 may be located opposite lateral portion 36.

As shown in FIGS. 1-3, in some embodiments an article of footwear 10 may include four ground surface material accumulation prevention structures, including one each in the toe region 24 and the ball of foot region 26 of the forefoot region 18, one in the midfoot region 22, and one in the heel region 20. Those skilled in the art readily will be able to select a design and configuration of ground surface material accumulation prevention structures suitable for a desired configuration of an article of footwear 10 and its intended use in view of the present disclosure.

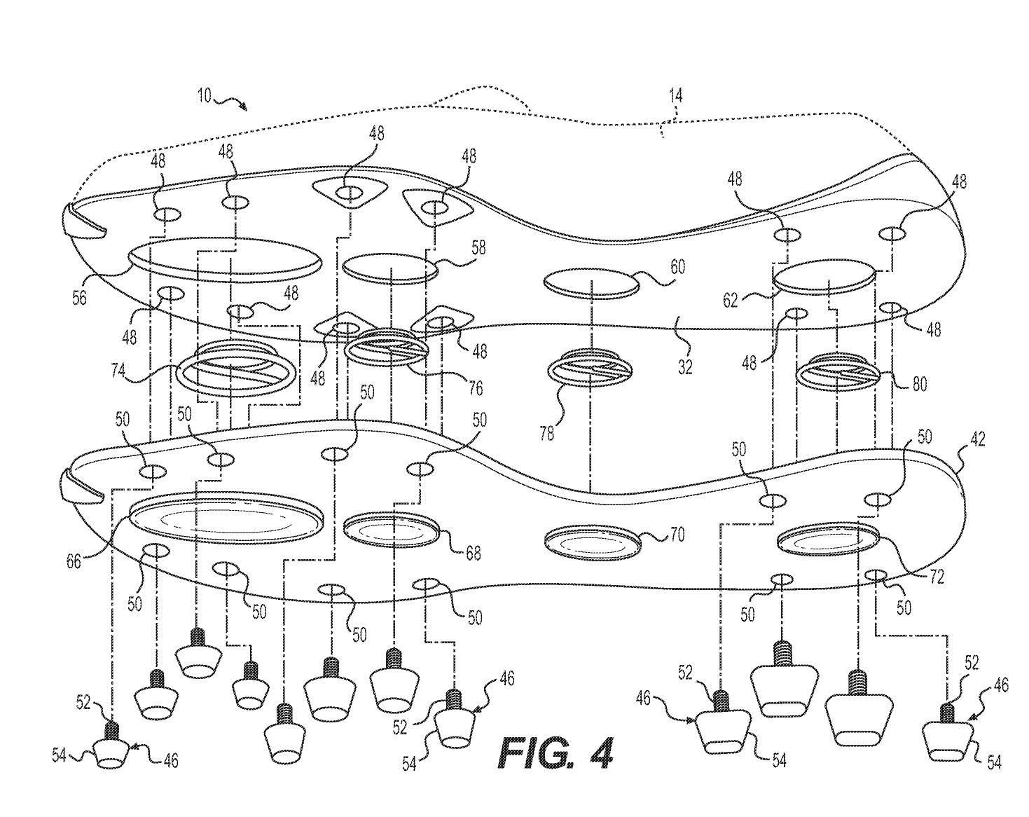

FIG. 4 is an exploded perspective view of the article of footwear 10 of FIGS. 1-3, illustrating an embodiment of ground surface material accumulation prevention structure for the article of footwear 10. The ground surface material accumulation prevention structure may include a web covering a spring element. For example, as shown in FIG. 4, article of footwear 10 may include a web 42 disposed over a portion of the lower surface 32 of the article of footwear 10, and a first spring element 74 disposed between the sole 16 and the web 42. The ground surface material accumulation prevention structure may include a plurality of spring elements. For example, as shown in FIG. 4, in addition to first spring element 74, a second spring element 76, a third spring element 78, and a fourth spring element 80 may be disposed between sole 16 and web 42. As shown in FIG. 4, in some embodiments, web 42 may cover substantially an entirety of the lower surface 32 of the article of footwear 10.

Web 42 may be secured to the lower surface 32 of the article of footwear 10. As shown in FIG. 4, in some embodiments, web 42 may be secured to the sole 16 by bonding or molding a perimeter of web 42 to a perimeter of sole 16. In some embodiments web 42 may have a substantially similar shape or “footprint” as the article of footwear 10. In some embodiments web 42 may have a configuration that substantially conforms to a shape and configuration of sole 16. In some embodiments, web 42 may be pre-molded with a configuration that conforms to a configuration of sole 16. As shown in FIG. 4, in some embodiments article of footwear 10 may include ground surface traction elements 17 including at least one removable cleat or stud 46. As shown in FIG. 4, in some embodiments article of footwear 10 may include plural removable cleats 46. In some embodiments, web 42 may be secured to the lower surface 32 of article of footwear 10 by at least one removable cleat 46. As shown in FIG. 4, in some embodiments sole 16 may include at least one female connector element 48, and web 42 may include at least one though-hole 50, for receiving a male connector element 52 of a removable cleat 46. In some embodiments, removable cleats 46 may support web 42 and at least one spring element on the sole 16 and lower surface 32 of the article of footwear 10.

Article of footwear 10 may include a sole 16 having an arrangement of plural ground surface traction elements 17. As shown in FIG. 4, in some embodiments sole 16 may include plural removable cleats or studs 46. Each removable cleat 46 may include a head 54 configured to contact an external ground surface and a male connector 52 configured to removably secure the cleat 46 to the lower surface 32 of sole 16. Each head 54 may have a configuration (size, shape, depth, width, length, orientation, etc.) selected for a desired application and intended use of the article of footwear. Exemplary shapes for cleats 46 include, but are not limited to, rectangular, hexagonal, cylindrical, conical, circular, square, trapezoidal, diamond, ovoid, as well as other regular or irregular and geometric or non-geometric shapes. Those skilled in the art readily will be able to select a shape and/or configuration of each cleat 46 based on a desired application or use of the article of footwear. As shown in FIG. 4, in some embodiments each male connector element 52 may be threaded and configured to screw into a threaded female connector 48 of sole 16. Those skilled in the art readily will appreciate alternative connector structures and configurations for removably securing cleat 46 to sole 16 of the article of footwear 10.

As shown in FIG. 4, in some embodiments article of footwear 10 may include four ground surface material accumulation prevention structures, one each in the toe region 24 and the ball of foot region 26 of the forefoot region 18, one in the midfoot region 22, and one in the heel region 20. The number and location of the surface material accumulation prevention structures is exemplary only. As discussed herein, this localized and overall configuration may provide a desired localized and overall ground surface material accumulation prevention function for the article of footwear 10.

A ground surface material accumulation prevention structure may be located within a duster of ground surface traction elements 17. As shown in FIG. 4, in some embodiments a ground surface material accumulation prevention structure may include a web 42 having a through-hole 50 associated with a respective ground surface traction element 17. A through-hole 50 may include structure configured for engaging a ground surface traction element 17 of the article of footwear 10. For example, as shown in FIG. 4, in some embodiments web 42 may include a through-hole 50 sized and configured to receive a male connector 52 of a removable cleat 46 to secure the web 42 of the ground surface material accumulation prevention structure to the lower surface 32 of sole 16 of the article of footwear 10.

As shown in FIGS. 1-4, in some embodiments a cluster may include four ground surface traction elements 17. However, it will be appreciated that a cluster may include a different number of ground surface traction elements 17, and that a ground surface traction element 17 may be included in more than one cluster. A number and configuration of ground surface traction elements 17 may vary based on a number of factors, including a size and intended use of the article of footwear 10 and a size, material, and configuration of ground surface traction elements 17. Those skilled in the art readily will be able to select a number and configuration of ground surface traction elements 17 suitable for a desired article of footwear 10 and intended use.

Sole 16 may include at least one recess for receiving and locating a spring element of a ground surface material accumulation prevention structure. As shown in FIG. 4, in some embodiments sole 16 may include a first recess 56 located in the toe region 24, a second recess 58 located in the ball of the foot region 26, a third recess 60 located in the midfoot region 22, and a fourth recess 62 located in the heel region 20. A shape and configuration of each recess 56, 58, 60, 62 may conform to a shape and configuration of a respective spring element of a ground surface material accumulation prevention structure. For example, as shown in FIG. 4, in some embodiments, first spring element 74 may be located in the toe region 24 may have a larger diameter than spring elements in the ball of foot region 26, midfoot region 22, and heel region 20. A size and configuration of a spring element and respective recess may be selected based on a number of factors, including a location on the sole, a size and configuration of a region of the sole, a number and configuration of ground surface traction elements, and desired reactive and/or performance characteristics of the spring element. Those skilled in the art readily will be able to select a size and configuration of a recess in the sole 16 for receiving a spring element of a ground surface material accumulation prevention structure.

Web 42 may optionally include at least one wear surface treated area corresponding to a spring element of a ground surface material accumulation prevention structure. As shown in FIG. 4, in some embodiments web 42 may include a first wear surface treated area 66 located in the toe region 24, a second wear surface treated area 68 located in the ball of the foot region 26, a third wear surface treated area 70 located in the midfoot region 22, and a fourth wear surface treated area 72 located in the heel region 20. A shape and configuration of each wear surface treated area 66, 68, 70, 72 may conform to a shape and configuration of a respective spring element of a ground surface material accumulation prevention structure. For example, as shown in FIG. 4, in some embodiments, first spring element 74 may be located in the toe region 24 and may have a larger diameter than other spring elements in the ball of foot region 26, midfoot region 22, and heel region 20. Those skilled in the art readily will be able to select a size and configuration of a wear surface treated area 66, 68, 70, 72 in the web 42 for a respective spring element of a ground surface material accumulation prevention structure.

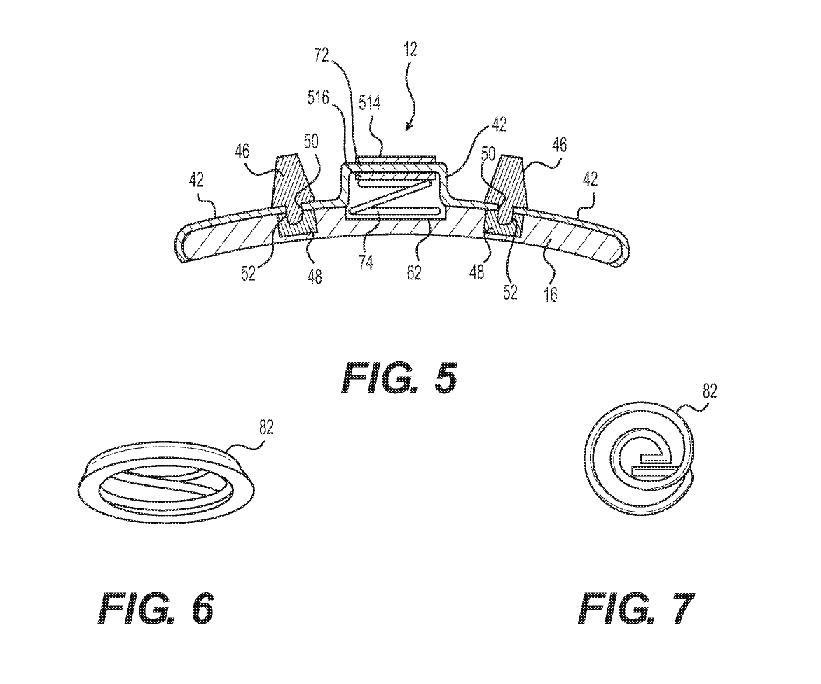

FIG. 5 is a cross-sectional view of ground surface material accumulation prevention structure 88 of FIG. 4 taken along section line 5-5 of FIG. 3. As shown in FIG. 5, in some embodiments article of footwear 10 may include a rigid sole plate 16 and a soft lining 501 disposed on an interior surface of sole plate 16. As shown in FIG. 5, in some embodiments at least a perimeter of web 42 may be bonded or molded to a perimeter of sole plate 16. As shown in FIG. 5, web 42 may be secured to sole 16 by removable cleats 46, where each cleat 46 includes a male connector element 52 that extends through a through-hole 50 in web 42 and into a female connector element 48 in sole 16. This configuration may prevent ground surface material from entering and accumulating in a gap at an interface between web 42 and sole 16. In some embodiments, the spring elements may be fixed to sole 16. In some embodiments, the spring elements may be bonded to sole 16. In some embodiments, a portion of the spring elements may be embedded in sole 16, e.g., by a molding process.

The ground surface material accumulation prevention structures may each include a wear surface treated area configured to contact an external ground surface. For example, fourth ground surface material accumulation prevention structure 88 may include fourth wear surface treated area 72. The wear surface treated area may include an external wear surface material and/or an internal wear surface material. For example, fourth wear surface treated area 72 may include an external wear surface material 514 and/or an internal wear surface material 516. As discussed herein, the spring elements may be configured to transition the respective wear surface treated areas between a first position and a second position in response to an external compression force applied by an external ground surface, to prevent accumulation of ground surface material compacting on the wear surface treated areas and lower surface 32 of the article of footwear 10.

The spring elements may be any known or later developed spring type having a size, configuration, and functional/performance characteristic suitable for operation in a ground surface material accumulation prevention structure. FIGS. 6 and 7 respectively illustrate first spring element 82 in a perspective view and top profile view. It is understood that second spring element 84, third spring element 86, and fourth spring element 88 may have the same shape as first spring element 82. As shown in FIGS. 6 and 7, in some embodiments, first spring element 82 may be a coil spring. As shown in FIGS. 6 and 7, in some embodiments, first spring element 82 may be circular. In some embodiments, first spring element 82 may have an alternative plan shape, such as a square, triangular, or other regular or irregular geometric shape. As shown in FIG. 7, in some embodiments, first spring element 82 may be a circular coil spring having at least one end portion terminating in a central area to facilitate securing first spring element 82 to sole plate 16, e.g., by bonding or molding process, and to prevent or minimize wear of an interior surface of web 42. In some embodiments, the spring elements may present a substantially flat interface with the respective wear surface treated areas. In some embodiments, the spring element may present a substantially dome shaped interface with the respective wear surface treated areas. In each case, the spring element 4 and the respective wear surface treated area may be configured to contact an external ground surface in active use of the article of footwear. Those skilled in the art readily will appreciate alternative types and configurations for the spring elements suitable for a desired application.

The spring elements may be configured to react in response to an externally applied force in active use of the article of footwear 10. The spring elements may be configured to compress in response to a compression force applied to the spring element (e.g., first spring element 82) via the respective wear surface treated area (e.g., wear surface treated area 516) by an external ground surface, to absorb and store a portion of energy from the applied compression force, and to generate a reactive spring force that biases the spring element to return to a non-compressed state upon release of the applied compression force.

The spring element may have any geometric shape that provides a desired reactive spring function characteristic. As shown in FIGS. 6 and 7, in some embodiments, first spring element 82 may have a circular or semi-spherical shape. This configuration may provide a reactive spring function characteristic that is substantially consistent regardless of a direction in which an external compression force is applied to the spring element, e.g., based on an orientation of the article of footwear 10 upon impact with an external ground surface. The spring element may have a symmetrical or non-symmetrical shape.

The spring element may have a base plan shape or footprint selected for a particular article of footwear configuration or application. The spring element may have a base plan shape or footprint configured for location in a particular area of the article of footwear 10. For example, first spring element 82 may be sized and shaped for located between a cluster of ground surface traction elements 17 in a selected one of the toe region 24 or ball of foot region 26 of the forefoot region 20, in the midfoot region, or in the heel region 20.

The spring element may be configured to provide a reactive spring force/functional characteristic in a selected direction. The spring element may be configured to provide a reactive spring force/functional characteristic in a direction associated with a location of the ground surface material accumulation prevention structure on the article of footwear 10. For example, the spring element may be located in the toe region 24 and configured to generate a reactive spring force/functional characteristic that acts in a proximal direction relative to the heel region 20.

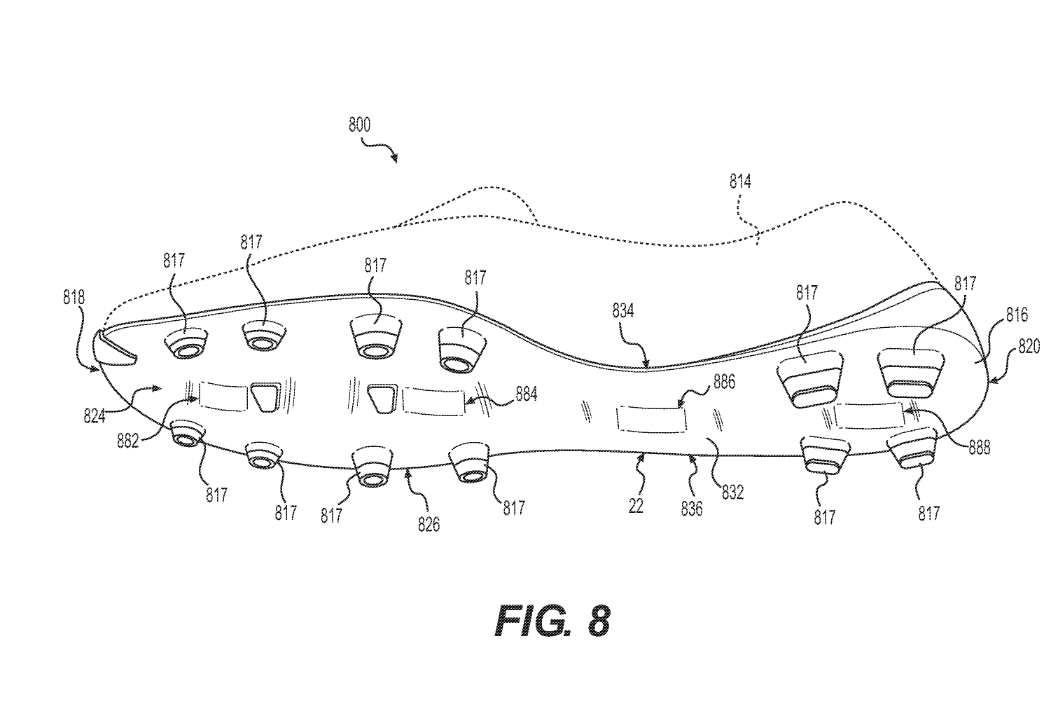

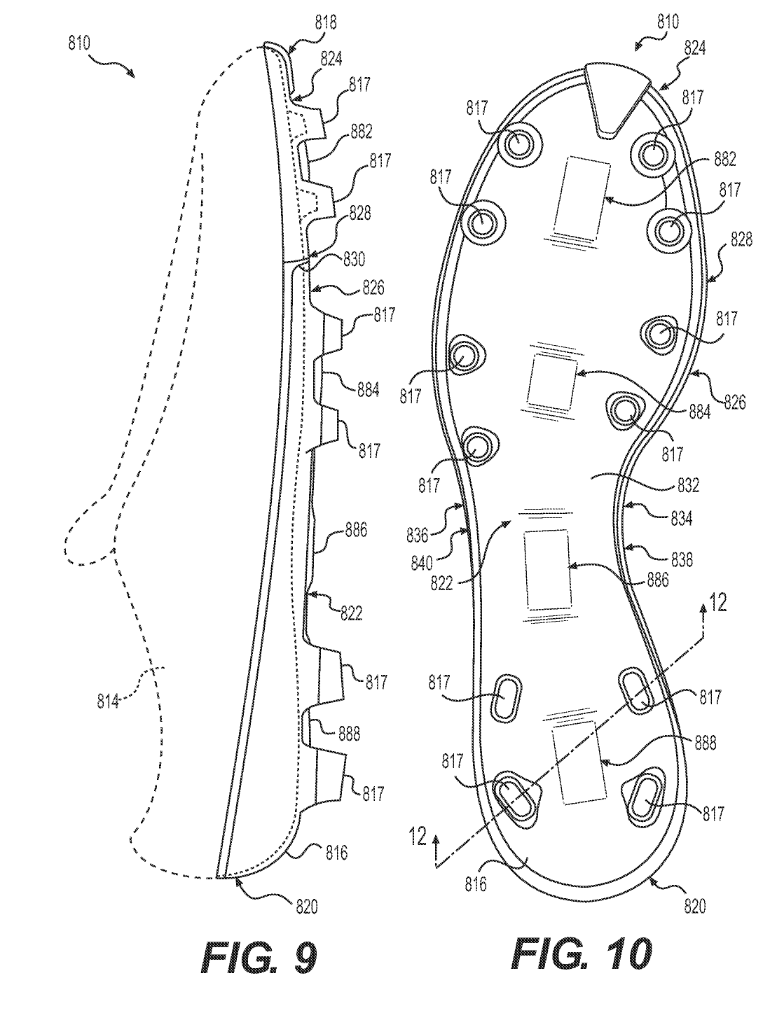

FIGS. 8-10 illustrate a second embodiment of an article of footwear including ground surface material accumulation prevention structure according to the present invention. FIG. 8 is a perspective view of an article of footwear 810 including a ground surface material accumulation prevention structure according to the present invention. A first ground surface material accumulation prevention structure 882, a second ground surface material accumulation prevention structure 884, a third ground surface material accumulation prevention structure 886, and a fourth ground surface material accumulation prevention structure 888. FIG. 9 is a side profile view of the article of footwear of FIG. 8. FIG. 810 is a plan view of a lower surface of a sole or sole plate of the article of footwear of FIG. 8. FIGS. 8-10 illustrate an exemplary configuration of the article of footwear 810 and ground surface material accumulation prevention structures. Those skilled in the art readily will appreciate alternative embodiments in view of the present disclosure.

Similar to the embodiment of FIGS. 1-3, as shown in FIGS. 8-10, in some embodiments, article of footwear 810 may include an upper (shown in phantom in dashed lines) 814, a sole or sole plate 816, and at least one ground surface traction element. Article of footwear 810 may include a forefoot region 818 (including a toe region 824 and a ball of foot region 826), a heel region 820, a flex region 828, a sipe 830, a medial portion 834 having a medial edge 838, and a lateral portion having a lateral edge. Article of footwear 810 may include at least one ground surface material accumulation prevention structure. In some embodiments, article of footwear 810 may include a plurality of ground surface material accumulation prevention structures. For example, as shown in FIGS. 8-10, article of footwear 810 may include 4 ground surface material accumulation prevention structures. In other examples, the article of footwear may include 2, 3, 5, 6, 7, or 8 ground surface material accumulation prevention structures. In the embodiment shown in FIGS. 8-10, first ground surface material accumulation prevention structure 882 may be disposed in the toe region 824, second ground surface material accumulation prevention structure 884 may be disposed in the ball of foot region 826 of the forefoot region 818, third ground surface material accumulation prevention structure 886 may be disposed in the midfoot region 822, and fourth ground surface material accumulation prevention structure 888 may be disposed in the heel region 820.

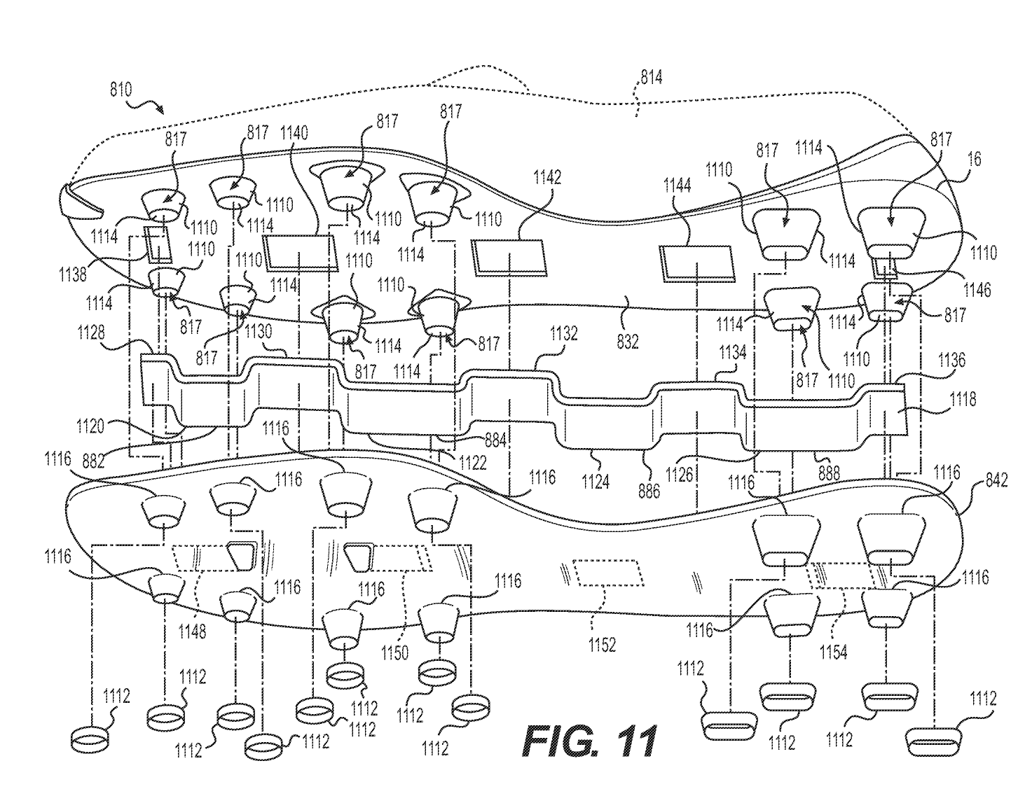

FIG. 11 is an exploded perspective view of the article of footwear 10 of FIGS. 8-10, illustrating an embodiment of ground surface material accumulation prevention structure for the article of footwear 810. As shown in FIG. 11, in some embodiments the article of footwear 810 may include a web 842 disposed over a portion of the lower surface 832 of the article of footwear 810. In some embodiments, the article of footwear may include at least one spring element disposed between the sole and the web. For example, as shown in FIG. 11, article of footwear 810 may include a spring member 1118 having a first spring element 1120 in the toe region 24, a second spring element 1122 in the ball of the foot region 26, a third spring element 1124 in the midfoot region 22, and a fourth spring element 1126 in the heel region 26. Spring member 1118 may further include a first spring base element 1128, a second spring base element 1130, a third spring base element 1132, a fourth spring base element 1134 and a fifth spring base element 1136. As shown in FIG. 11, in some embodiments, web 842 may cover substantially an entirety of the lower surface 832 of the article of footwear 810.

Web 842 may be secured to the lower surface 832 of the article of footwear 810. As shown in FIG. 11, in some embodiments, web 842 may be secured to the sole 816 by bonding or molding a perimeter of web 842 to a perimeter of sole 816. In some embodiments web 842 may have a substantially similar shape or “footprint” as the article of footwear 810. In some embodiments web 842 may have a configuration that substantially conforms to a shape and configuration of sole 816. In some embodiments, web 842 may be pre-molded with a configuration that conforms to a configuration of sole 816, optionally including a configuration of ground surface traction elements 817. As shown in FIG. 11, in some embodiments article of footwear 810 may include ground surface traction elements 817 that are co-molded on sole plate 816. In some embodiments, sole plate 816 may include at least one fixed cleat 1110. In some embodiments, web 842 may be secured to the lower surface 832 of article of footwear 810 by the at least one cleat 1110. As shown in FIG. 11, in some embodiments, web 842 may be configured to follow a contour of a cleat 1110, and article of footwear 810 may include at least one clip 1110 for receiving and capturing a cleat 1110, e.g., by press fit or a molding process. In some embodiments, a cleat 1110 and respective clip 1112 may support web 842 and at least one spring element 844 on the sole 816 and lower surface 832 of the article of footwear 810.

Article of footwear 810 may include a sole 816 having an arrangement of plural ground surface traction elements 817. As shown in FIG. 11, in some embodiments sole 816 may include plural cleats 1110. Each cleat 1110 may include a head 1114 configured to contact an external ground surface. Each head 1114 may have a configuration (size, shape, depth, width, length, orientation, etc.) selected for a desired application and intended use of the article of footwear 810. Exemplary shapes for cleats 846 include, but are not limited to, rectangular, hexagonal, cylindrical, conical, circular, square, trapezoidal, diamond, ovoid, as well as other regular or irregular and geometric or non-geometric shapes. Those skilled in the art readily will be able to select a shape and/or configuration of each cleat 1114 based on a desired application or use of the article of footwear. As shown in FIG. 11, each cleat 1110 may have a respective clip 1112 having a configuration corresponding to a configuration of the cleat 1110, so that the clip 1112 may be secured on cleat 1110, e.g., by press fit, by bonding, or by molding process. In this manner, a clip 1112 may become an exposed portion of a ground surface traction element 817 suitable for contacting an external ground surface in active use of the article of footwear 180. Those skilled in the art readily will appreciate alternative cleat and clip structures and configurations for securing clip 1112 to cleat 1110 of sole 816 of the article of footwear 810.

At least one of the ground surface material accumulation prevention structures may be located within a cluster of ground surface traction elements 817. As shown in FIG. 11 (see dashed lines at base of ground-surface-traction-element-shaped protrusions), in some embodiments web 842 may have a through-hole 1116 associated with a respective cleat 1110 of a duster of ground surface traction elements 817. Through-hole 1116 may include structure configured for engaging base of a cleat 1110 of the article of footwear 810. In this manner, it will be appreciated that a cleat 1110 may facilitate securing web 842 to sole 816 of the article of footwear 810 without a clip. In some embodiments, a portion of web 842 may be bonded or molded to sole 816 at least around a perimeter of a cleat 1110. In this manner, web 842 may be secured to sole 816 so that ground surface material may not be introduced into a gap at the interface between the web 842 and sole 816. Those skilled in the art readily will appreciate alternative configurations and methods for securely supporting web 842 on sole 816.

As shown in FIGS. 8-11, in some embodiments a cluster may include four ground surface traction elements 817. However, it will be appreciated that a cluster may include a different number of ground surface traction elements 817, and that a ground surface traction element 817 may be included in more than one cluster. A number and configuration of ground surface traction elements 817 may vary based on a number of factors, including a size and intended use of the article of footwear 810 and a size, material, and configuration of ground surface traction elements 817. Those skilled in the art readily will be able to select a number and configuration of ground surface traction elements 817 suitable for a desired article of footwear 810 and intended use.

Sole 816 may include at least one recess for receiving and locating a portion of a spring element of a ground surface material accumulation prevention structure. As shown in FIG. 11, in some embodiments first spring base member 1128 may be located first recess 1138 in the toe region 824, second spring base element 1130 may be located in second recess 1140 in the ball of the foot region 826, third spring base element 1132 may be located in third recess 1142 in the midfoot region 822, fourth spring base element 1134 may be located in fourth recess 1144 in the midfoot region 822, and fifth spring base element 1136 may be located in fifth recess 1146 in the heel region 820. A shape and configuration of each of the recesses may conform to a shape and configuration of the respective spring base elements. For example, as shown in FIG. 11, in some embodiments, each recess may have a generally rectangular shape. A shape and configuration of each spring element (e.g., 1120, 1122, 1124, 1126) may be selected based on a number of factors. Exemplary factors include a reactive spring force and/or a performance characteristic of the article of footwear 810. In some embodiments, a shape and configuration of one or more spring elements may be substantially the same. In some embodiments, a shape and configuration of one spring element may be different from at least one other spring element. As shown in FIG. 11, in some embodiments second spring element 1122 located in the ball of the foot region 826 may be larger than first spring element 1128 located in the toe region 824. In this manner, second spring element 1122 may provide a greater reactive spring force characteristic. Those skilled in the art readily will be able to select a shape, size, and configuration of each spring element suitable for obtaining a reactive spring force for a desired performance characteristic of article of footwear 810.

Web 842 may optionally include at least one wear surface treated area corresponding to a spring element 844 of a ground surface material accumulation prevention structure. As shown in FIG. 11, in some embodiments web 842 may include a first wear surface treated area 1148 located in the toe region 824, a second wear surface treated area 1150 located in the ball of the foot region 826, a third wear surface treated area 1152 located in the midfoot region 822, and a fourth wear surface treated area 1154 located in the heel region 820. A shape and configuration of each the wear surface treated areas may conform to a shape and configuration of the respective spring elements of a ground surface material accumulation prevention structure. For example, as shown in FIG. 11, in some embodiments a first spring element 1120 and first wear surface treated area located in the toe region 824 may have a smaller plan area than a second spring element 1122 and second wear surface treated area 1150. Those skilled in the art readily will be able to select a size and configuration of the wear surface treated area of web 842 for the respective spring element of ground surface material accumulation prevention structure.

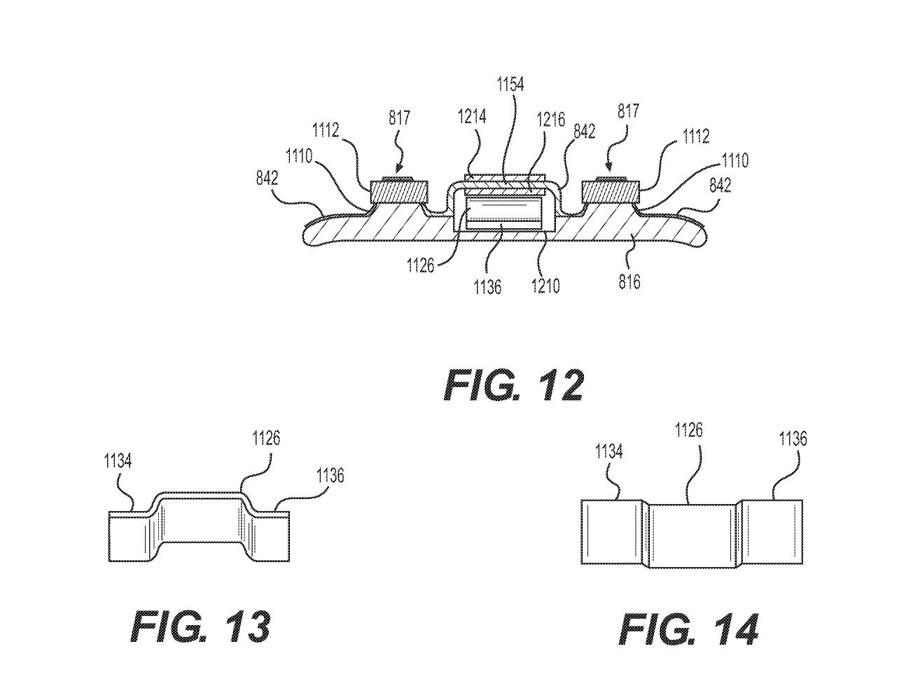

FIG. 12 is a cross-sectional view of fourth ground surface material accumulation prevention structure 888 of FIG. 11 taken along section line 12-12 of FIG. 10. As shown in FIG. 12, web 842 may be disposed over a portion of sole 816 and fourth spring element 1126 may be disposed between sole 816 and web 842. In some embodiments, web 842 may be secured to sole 816. As shown in FIG. 12, in some embodiments at least a perimeter of web 842 may be bonded or molded to a perimeter of sole plate 816. This configuration may prevent ground surface material from entering and accumulating in a gap at an interface between web 842 and sole 816. As shown in FIG. 12, web 842 may be secured to cleats 1110 of sole 816 by clips 1112. This configuration may prevent web 842 from separating from sole 816 in active use of the article of footwear 810.

As shown in FIG. 12, in some embodiments a spring base element (e.g., fifth spring base element 1136) may be located and seated in a recess (e.g., fifth recess 1146) at heel region 820. In some embodiments, the spring base element may be fixed to sole 816. In some embodiments, the spring base element may be bonded to sole 816. In some embodiments, the spring element may be embedded in sole 816, e.g., by a molding process.

The wear surface treated areas may be configured to contact an external ground surface. Fourth wear surface treated area 1154 optionally may include an external wear surface material 1214 and/or an internal wear surface material 1216. As discussed herein, fourth spring element 1126 may be configured to transition fourth wear surface treated area 1154 between a first position and a second position in response to an compression force applied by an external ground surface, to prevent accumulation of ground surface material compacting on fourth wear surface treated area 1154 and lower surface 832 of the article of footwear 810.

The spring member 1118 may be any known or later developed spring type having a size, configuration, and functional/performance characteristic suitable for operation in a ground surface material accumulation prevention structure. FIGS. 13 and 14 respectively illustrate fourth spring element 1126 in a perspective view and top profile view. As shown in FIGS. 13 and 14, in some embodiments, fourth spring element 1126 may be a spring element of a serpentine spring member 1118. It is understood that the other spring elements may have the same general shape as fourth spring element 1126. As shown in FIGS. 13 and 14, in some embodiments, fourth spring element 1126 may present a generally flat top surface (e.g., a step portion of spring member 1118). In some embodiments, fourth spring element 1126 may have an alternative surface shape, such as an arched or curved shape. As shown in FIGS. 12-14, in some embodiments, fourth spring element 1126 may be a leaf spring. In each case, fourth spring element 1126 and fourth wear surface treated area 1154 may be configured to contact an external ground surface in active use of the article of footwear 810. Those skilled in the art readily will appreciate alternative types and configurations for spring member 1118 suitable for a desired application.

Fourth spring element 1126 may be configured to react in response to an externally applied force in active use of the article of footwear 10. Fourth spring element 1126 may be configured to compress in response to a compression force applied to the fourth spring element 1126 via fourth wear surface treated area 1154 of web 842 by an external ground surface, to absorb and store a portion of energy from the applied compression force, and to generate a reactive spring force that biases the fourth spring element 1126 to return to a non-compressed state upon release of the applied compression force.

Fourth spring element 1126 may have any geometric shape that provides a desired reactive spring function characteristic. As shown in FIGS. 13 and 14, in some embodiments, fourth spring element 1126 may have a generally rectangular shape. This configuration may provide a reactive spring function characteristic that is substantially consistent regardless of a direction in which an external compression force is applied to fourth spring element 1126, e.g., based on an orientation of the article of footwear 810 upon impact with an external ground surface. Fourth spring element 1126 may have a symmetrical or non-symmetrical shape.

Fourth spring element 1126 may have a base plan shape or footprint selected for a particular article of footwear configuration or application. Fourth spring element 1126 may have a base plan shape or footprint configured for location in a particular area of the article of footwear 810. For example, fourth spring element 1126 may be sized and shaped for location between a cluster of ground surface traction elements 817 in a selected one of the toe region 824 or ball of foot region 826 of the forefoot region 820, in the midfoot region, or in the heel region 820.

Fourth spring element 1126 may be configured to provide a reactive spring force/functional characteristic in a selected direction. Fourth spring element 1126 may be configured to provide a reactive spring force/functional characteristic in a direction associated with a location of fourth ground surface material accumulation prevention structure 888 on article of footwear 810. For example, first spring element 1120 may be located in the toe region 824 and configured to generate a reactive spring force/functional characteristic that acts in a proximal direction relative to the heel region 820.

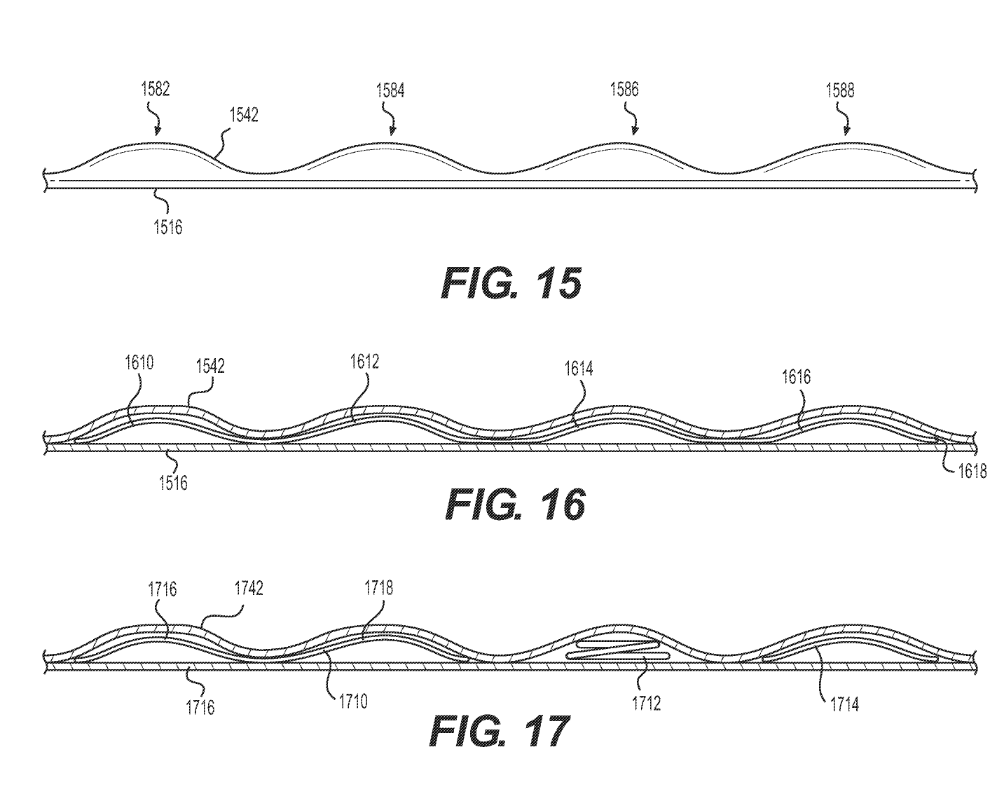

FIGS. 15 and 16 schematically illustrate an embodiment of a first ground surface material accumulation prevention structure 1582, a second ground surface material accumulation prevention structure 1584, a third ground surface material accumulation prevention structure 1586, and a fourth ground surface material accumulation prevention structure 1588. FIG. 15 is a schematic perspective side view of the ground surface material accumulation prevention structures. FIG. 16 illustrates a single serpentine shaped leaf spring member 1618, including first spring element 1610, a second spring element 1612, a third spring element 1614, and a fourth spring element 1616. A web 1542 may cover the spring elements. The spring elements may lie against a sole plate 1516. It is understood that the embodiment shown in FIGS. 15 and 16 may include other parts of an article of footwear, e.g., an upper.

FIG. 17 schematically illustrates an alternative configuration of ground surface material accumulation prevention structure. As shown in FIG. 17, in some embodiments, an article of footwear may include a sole or sole plate 1716, a web 1742, and plural different types of spring members. For example, as shown in FIG. 17, in some embodiments, an article of footwear may include a first spring member 1710, a second spring member 1712, and a third spring member 1714. First spring member 1710 may be a serpentine spring member having a first leaf spring element 1716 and a second leaf spring element 1718. Second spring member 1712 may be a coil spring element. Third spring element 1122 may be a single leaf spring. Those skilled in the art readily will be able to select a combination of spring elements suitable for obtaining an article of footwear and ground surface material accumulation prevention structure having desired configuration, functional, and performance characteristics.

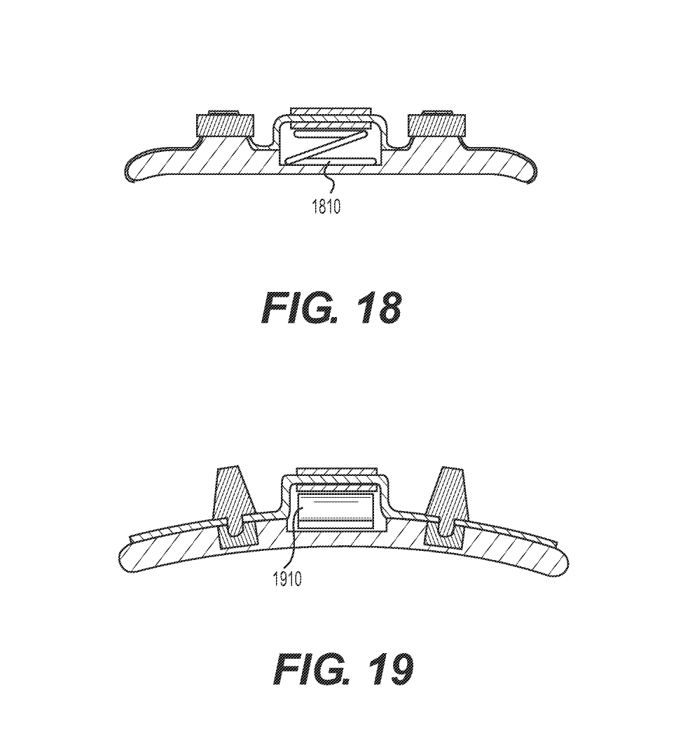

FIG. 18 is a cross-sectional view of an embodiment of a ground surface material accumulation prevention structure of an embodiment in which an article of footwear has the cleats of the embodiment shown in FIGS. 8-14. The ground surface material accumulation prevention structure may include a coil spring element 1810. In some embodiments, coil spring element 1810 may have a structure and configuration as discussed with respect to FIGS. 1-7.

FIG. 19 is a cross-sectional view of an embodiment of ground surface material accumulation prevention structure of an embodiment in which an article of footwear has the cleats of the embodiment shown in FIGS. 1-7. The ground surface material accumulation prevention structure may include a leaf spring element 1910. In some embodiments, leaf spring element 1910 may have a structure and configuration as discussed with respect to FIGS. 8-14.

Molding System for Molding Sole Plate with Ground Surface Material Accumulation Prevention Structure

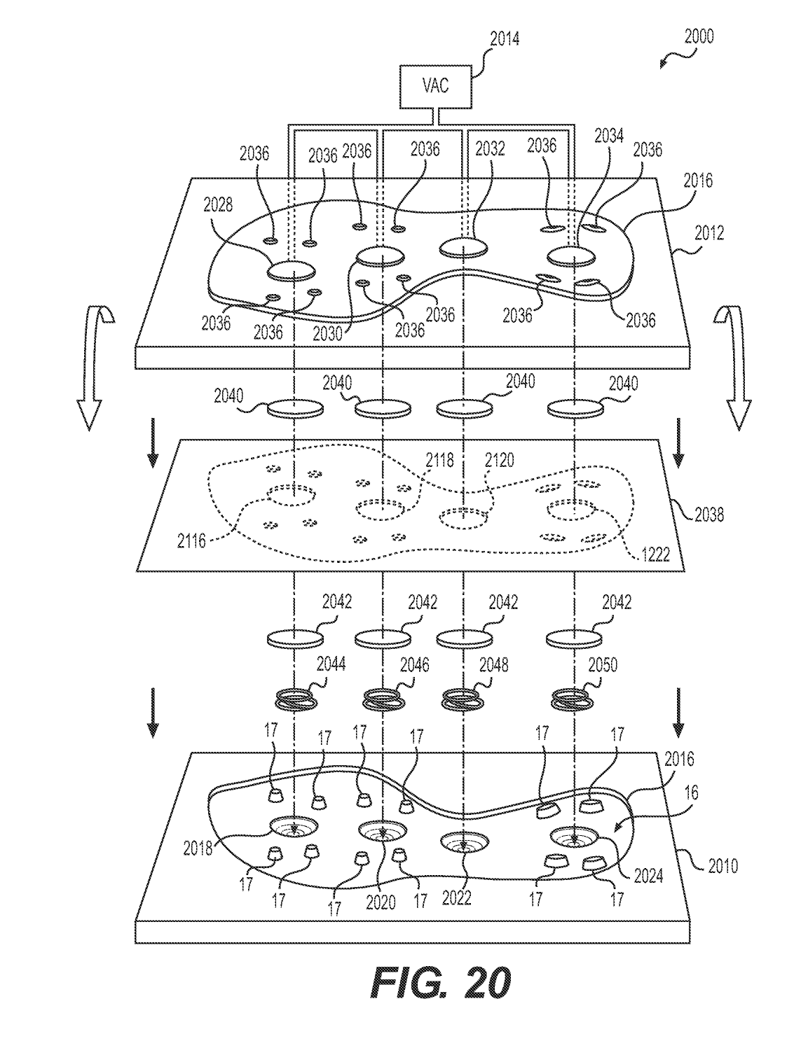

FIG. 20 illustrates an embodiment of a molding system 2000 for molding a sole plate for an article of footwear, where the sole plate includes ground material accumulation prevention structure. In some embodiments, molding system 2000 may include provisions for making a matched pair of sole plate. FIG. 20 illustrates molding system 2000 in an exploded, open mold configuration.

As shown in FIG. 20, in some embodiments molding system 2000 may include a lower mold plate 2010, an upper mold plate 2012, and an optional vacuum system 2014. In some embodiments, molding system 2000 may include additional components typically associated with a compression or thermal molding system, including components not described herein.

Lower mold plate 2010 may include a lower sole plate recess 2016 sized and configured to receive a sole or sole plate 16 for an article of footwear 10 and to mold ground surface material accumulation prevention structure 12 on sole plate 16. As shown in FIG. 20, a sole plate 16 suitable for use in the present method may be seated in lower sole plate recess 2016 for a molding process.

Sole plate 16 may be a known or later developed sole plate having a known or later developed configuration and made of a known or later developed material. In some embodiments, sole plate 16 may include at least one ground surface traction element 17. In some embodiments, sole plate 16 may include at least one cluster of ground surface traction elements 17. As shown in FIG. 20, in some embodiments sole plate 16 may include three clusters of four ground surface traction elements 17, one each in the toe region 24 and ball of the foot region 26 of the forefoot region 18, and one in the heel region 20 of the sole 16.

Sole plate 16 may include at least one reaction spring element recess formed in the lower surface 32 of sole plate 16 for receiving a spring element 44 and configured to mold ground surface material accumulation structure 12. As shown in FIG. 20, in some embodiments sole plate 16 may include a first circular recess 2018 located in the toe region 24, a second circular recess 2020 located in the ball of the foot region 26, a third circular recess 2022 located in the midfoot region 2022, and a four circular recess 2024 located in the heel region 20, with recess 2018, recess 2020, and recess 2024 respectively located among the three clusters of ground surface traction elements 17 in the toe region 24, the ball of foot region 26, and the heel region 20.

Upper mold plate 2012 may include an upper sole plate recess 2026 sized and configured to receive a lower surface 32 of sole plate 16 and to mold ground surface material accumulation structure 12 on sole plate 16. Upper sole plate recess 2026 may include at least one upper reaction spring cavity for receiving a reaction spring element in a molding process. As shown in FIG. 20, in some embodiments upper mold plate 2012 may include a first upper reaction spring cavity 2028 located in the toe region 24, a second upper reaction spring cavity 2030 located in the ball of the foot region 26, a third upper reaction spring cavity 2032 located in the midfoot region, and a fourth upper reaction spring cavity 2034 located in the heel region. Upper mold plate 2012 may include at least one ground surface traction element cavity 2036 for receiving a ground surface traction element 17 of sole plate 16 in a molding process. As shown in FIG. 20, in some embodiments upper mold plate 2012 may include three clusters of four ground surface traction element cavities 2036, one each located in the toe region 24 and the ball of foot region 26 of the forefoot region 18, and one located in the heel region 20.

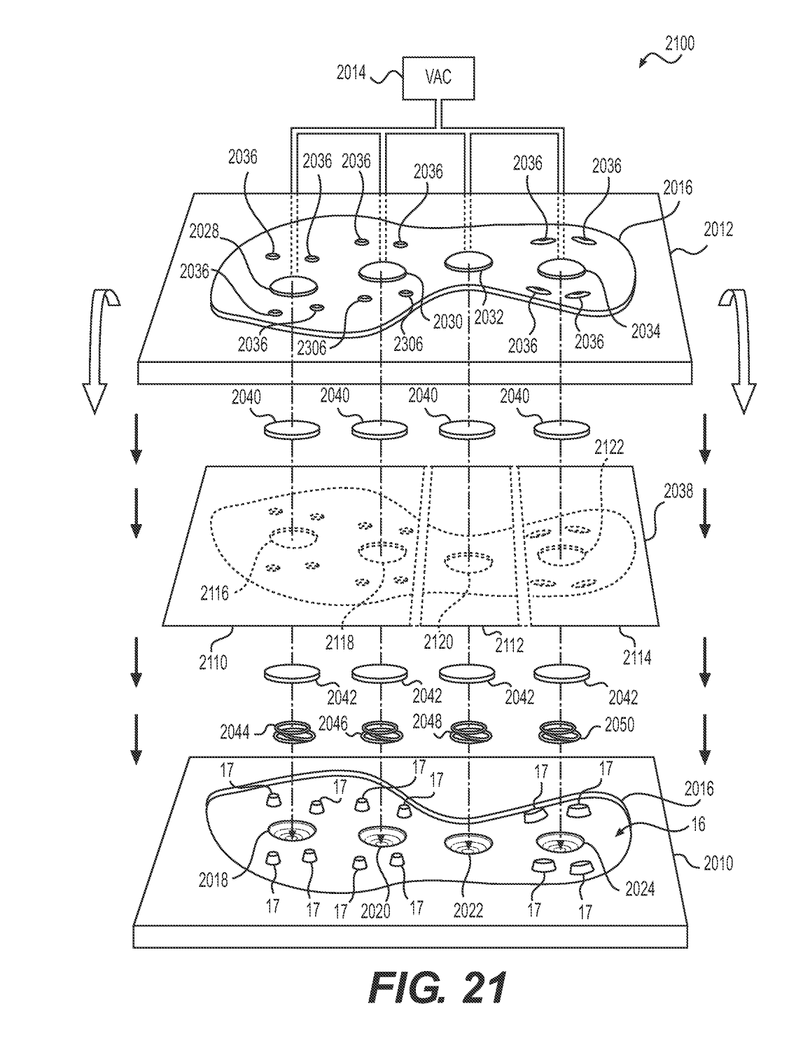

In a molding process, a first spring element 2044 may be disposed in first circular recess 2018, a second spring element 2046 may be disposed in second circular recess 2020, a third spring element 2048 may be disposed in third circular recess 2022, and a fourth spring element 2050 may be disposed in fourth circular recess 2024, and a sheet of mold material 2038 may be disposed between the lower mold plate 2010 and the upper mold plate 2012 in registration with lower sole plate recess 2016 and upper sole plate recess 2026. As shown in FIG. 20, in some embodiments, the sheet of mold material 2038 may be pre-cut or pre-formed into a mold blank 2040 (shown in phantom by dotted lines) by cutting the sheet of mold material 2038 to conform a perimeter of the mold material blank 2040 with a perimeter of the sole plate 16. As shown in FIG. 20, the sheet of mold material 2038 optionally may be pre-cut or pre-formed to include a plurality of through-holes configured and registered for receiving ground surface traction elements 17 in a molding process. In some embodiments, a sheet of molding material 2038 may include at least one wear surface treated area corresponding to a reactive spring element. For example, as shown in FIG. 21, sheet of molding material 2038 may include a first wear surface treated area 2116, a second wear surface treated area 2118, a third wear surface treated area 2120, and a fourth wear surface treated area 2122 corresponding, respectively, to first reactive spring element 2044, second reactive spring element 2046, third reactive spring element 2046, and fourth reactive spring element 2048. External wear surface materials 2040 and internal wear surface materials 2042 may be affixed to the wear surface treated areas.

In some embodiments, a wear resistant surface treated material optionally may be disposed between the sheet of molding material 2038 and lower mold plate 2010 or upper mold plate 2012, respectively, so that the wear resistant surface treated material is located in registration with a spring element. In a molding process, one or more exterior wear surface material blank 2044 and/or one or more interior wear surface material blank 2046 may be disposed within the molding system 2000 in registration with a spring element. For example, one or more exterior wear surface material blank 2044 and/or one or more interior wear surface material blank 2046 may be disposed within the molding system 2000 in registration with first spring element 2044, second spring element 2046, third spring element 2048, and fourth spring element 2050.

Upper mold plate 2012 may include optional vacuum system elements for facilitating a molding process. In some embodiments, upper reaction spring cavities 2028, 2030, 2032, 2034 may include vacuum ports 2056 connected to a central source of vacuum system 2014 by a vacuum manifold system (shown in phantom by dotted lines). Vacuum ports 2056 may be arranged on a mold cavity surface of the reaction spring cavities 2028, 2030, 2032, 2034 and configured to draw a portion of the sheet of mold material 2038 into the reaction spring cavities 2028, 2030, 2032, 2034 to form respective wear surface areas.

Lower mold plate 2010 and upper mold plate 2012 may be closed to perform a molding process. In some embodiments, a molding process may bond or mold a sheet of molding material 2038 to sole plate 16. In some embodiments, the molding process may bond or mold a sheet of molding material 2038 to a perimeter of sole plate 16. In some embodiments, the molding process may bond or mold a sheet of molding material 2038 to other portions of sole plate 16. In some embodiments, a sheet of molding material 2038 may be bonded or molded to a ground surface traction element 17 and/or a portion of sole plate 16 at a base of a ground surface traction element 17. In this manner, a molding process may form a web 42 disposed over a portion of the lower surface 32 of sole plate 16 so as to prevent ground surface material from entering a gap between the web 42 and the lower surface 32 of sole plate 16 during active use of an article of footwear 10. Those skilled in the art readily will appreciate alternative molding processes for obtaining a sole plate 16 having ground surface material accumulation prevention structure 12 as disclosed herein.

A molding process may include any known or later developed heat treatment and/or pressure treatment, with optional vacuum. In a molding process a sheet of mold material 2038 may be drawn by vacuum into the upper mold cavities (2028, 2030, 2032, 2034) and take a shape and configuration conforming to the shape and configuration of a mold surface of the upper mold cavities (2028, 2030, 2032, 2034). The sole plate 16, sheet of mold material 2038, and optional exterior and/or interior wear surface material blanks 2052, 2054 may be molded together to form a sole plate having a molded ground surface material accumulation prevention structure 12 having an integral/unitary structure.

Molding system 2000 may be opened to remove a molded product. In some embodiments, any extra molding material formed on a molded product may be removed from the molded product prior to securing sole plate 16 to an upper 14 to form an article of footwear 10.

Mold material for a molding process in molding system 2000 of FIG. 20 may be any known or later developed mold material(s) suitable for a desired ground surface material accumulation prevention structure 12. In some embodiments the molding material may be a thermoforming or thermosetting material. In some embodiments, the molding material may be a plastic material. In different embodiments, however, various types of molding material may be used to form a sole plate using molding system 2000. In some embodiments, the molding material may include, but is not limited to, any one or more of the following materials: natural or synthetic rubber, hard foam, plastics, polymers, nylon, polyurethane, thermoplastic polyurethane (TPU), as well as any other deformable or rigid materials. However, it will be understood that any other materials could be used as molding material. In addition, in some embodiments, a molded sole plate 16 having integral molded ground surface material accumulation prevention structure 12 may be produced using more than one molding material.

As shown in FIG. 20, in some embodiments the molding material may be in the form of a sheet of mold material 2038. In some embodiments the sheet of mold material 2038 and optional exterior and interior wear surface material blanks 2052, 2054 may be different mold materials. In some embodiments the molding material may be mold compatible with a material of sole plate 16. Those skilled in the art readily will be able to select various combinations of mold materials suitable for a particular application.

FIG. 21 illustrates an alternative embodiment of a molding system 2100 for molding a sole plate for an article of footwear, where the sole plate includes a ground surface material accumulation prevention structure. As shown in FIG. 21, in some embodiments molding system 2100 and a molding process may be substantially similar to molding system 2000 and a molding process of FIG. 20. Accordingly, this disclosure will discuss differences in molding system 2100 and a molding process of FIG. 21.

FIG. 21 illustrates an embodiment of molding system 2100 in an exploded, open mold configuration. As shown in FIG. 21, in some embodiments a sheet of mold material 2038 may be replaced with one or more mold material sheet segments. As shown in FIG. 21, in some embodiments sheet of mold material 2038 may be replaced with a first molding material sheet segment 2110 located in the forefoot region 18, a second molding material sheet segment 2112 located in the midfoot region 22, and/or a third molding material sheet segment 2114 located in the heel region 20. One or more of molding material sheet segments 2110, 2112, 2114 may be pre-formed or pre-cut to provide a mold blank that is sized and configured to correspond to a size and configuration of a target region 18, 22, 20 of sole plate 16, as shown in phantom by dashed lines in FIG. 21. In some embodiments, one, two, and/or all three of sheet segments 2110, 2112, 2114 (or a corresponding molding material blank, as shown in respective dashed lines) selectively may be used in any combination. In this manner, a molding system and process may form a web 42 that covers a portion of the lower surface 32 of sole plate 16. Those skilled in the art readily will appreciate that other sheet segments of molding material may be used. For example, in some embodiments a sheet segment that covers a portion of sole plate 16 corresponding to only a toe region or a portion of sole plate 16 corresponding to the midfoot region 22 and the heel region 20 may be used. In each case, a sheet segment may be bonded or molded to the lower surface 32 of sole plate 16 to form a web 42 of ground surface material accumulation prevention structure 12. In some embodiments, a perimeter of a sheet segment may be bonded or molded to the lower surface 32 of sole plate 16. In some embodiments, a portion of sheet segment may be bonded or molded to a transverse portion of sole plate 16 that extends substantially from a medial edge 38 to a lateral edge 40 of sole plate 16. In some embodiments, a portion of a sheet segment may be bonded or molded adjacent a ground surface traction element 17 of sole plate 16. In each case, bonding or molding a sheet segment to sole plate 16 may facilitate prevention of ground surface material from entering a gap at an interface between the lower surface 32 of sole plate 16 and a web 42 formed by the sheet of molding material. Those skilled in the art readily will appreciate alternative embodiments suitable for a particular application or configuration of sole plate 16.

In a molding process, a sheet segment 2110, 2112, 2114 may be disposed between the lower mold plate 2010 and upper mold plate 2012, optionally with corresponding external wear surface material 2052 and/or internal wear surface material 2054. In some embodiments, the molding process may be a compression or thermal molding process. After compression or thermal molding process, molding system 2100 may be opened to remove a molded sole plate 16 having ground surface material accumulation prevention structure 12.

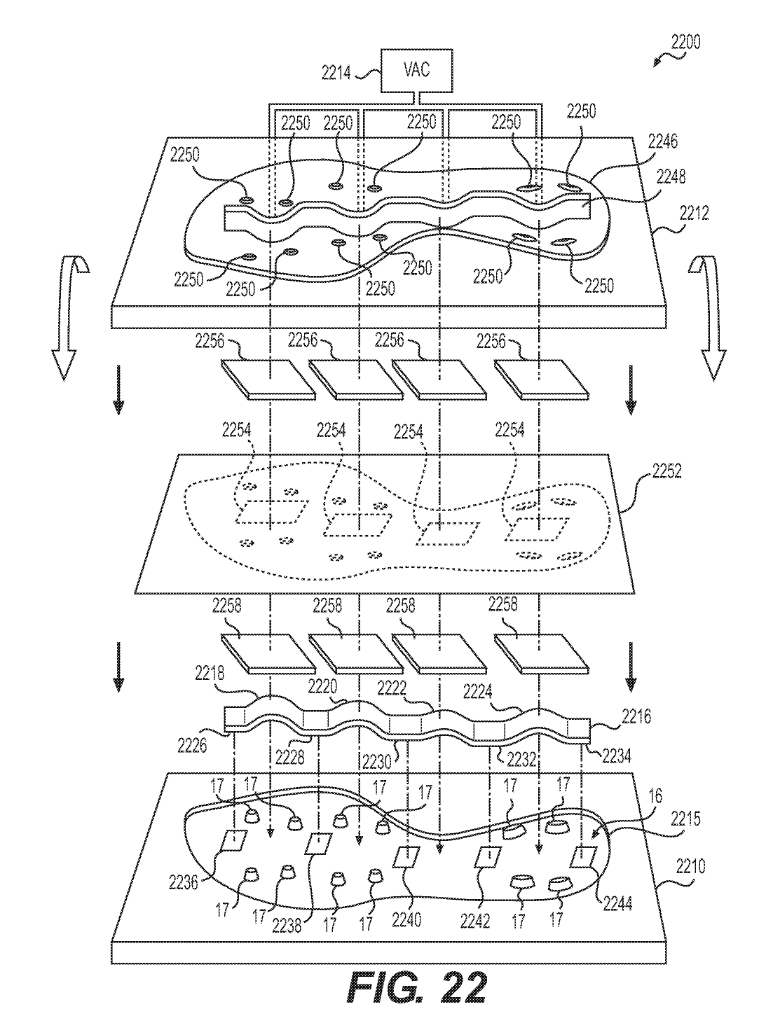

FIG. 22 illustrates an alternative embodiment of a molding system 2200 for molding a sole plate for an article of footwear, where the sole plate includes ground surface material accumulation prevention structure. As shown in FIG. 22, in some embodiments molding system 2200 and a molding process may be substantially similar to molding system 2000 and a molding process of FIG. 20. Accordingly, this disclosure will describe differences in molding system 2200 and a molding process of FIG. 22.

FIG. 22 illustrates an embodiment of molding system 2200 in an exploded, open mold configuration. As shown in FIG. 22, in some embodiments molding system 2200 may include a lower mold plate 2210, an upper mold plate 2212, and an optional vacuum system 2214. In some embodiments, molding system 2200 may include additional components typically associated with a compression or thermal molding system, including components not described herein.

As shown in FIG. 22, in some embodiments, sole plate 16 and molding system 2200 may be configured for molding a sole plate 16 having ground surface material accumulation prevention structure 12 including a serpentine leaf spring member 2216.

A serpentine leaf spring may include plural leaf spring elements. As shown in FIG. 22, in some embodiments, serpentine leaf spring member 2016 may include a first spring element 2218 located in a toe region 24, a second spring element 2220 located in a ball of the foot region 26, a third spring element 2222 located in a midfoot region 22, and a fourth spring element 2224 located in a heel region 20. Serpentine spring member 2016 may include spring base elements for locating and securing serpentine spring member 2016 on sole plate 16. As shown in FIG. 22, in some embodiments serpentine leaf spring member 2016 may include a first spring base element 2226 located in the toe region 24, a second spring base element 2228 located in the ball of the foot region 26, a third spring base element 2230 located in the midfoot region 22, a fourth spring base element 2232 located in the midfoot region 22, and a fifth spring base element 2234 located in the heel region 20.

Lower sole plate 2210 may include a sole plate recess 2215 for receiving a sole plate 16 in a molding process. As shown in FIG. 22, in a molding process sole plate 16 may be set in the sole plate recess 2215.

Sole plate 16 may include molding cavities for receiving and securing serpentine spring member 2016 thereon. As shown in FIG. 22, in some embodiments sole plate 16 may include first spring base cavity 2236 located in toe region 24, second spring base cavity 2238 located in ball of foot region 26, third spring base cavity 2240 located in midfoot region 22, fourth spring base cavity 2242 located in midfoot region 22, and fifth spring base cavity 2244 located in heel region 20. Each spring base cavity may be sized and configured to receive and support a respective spring base element of serpentine spring member 2016. In a molding process, a spring base cavity may be configured to bond to or mold with a respective spring base element of serpentine spring member 2016.

Upper mold plate 2212 may be provided with mold cavities corresponding to features of sole plate 16 and serpentine spring member 2216. As shown in FIG. 22, in some embodiments upper mold plate 2212 may include an upper sole plate recess 2246 sized and configured to receive a lower surface 32 of sole plate 16. As shown in FIG. 22, in some embodiments mold plate 2212 may include a mold spring cavity 2248 sized and configured to receive serpentine spring member 2016. In some embodiments, mold plate 2212 may include one or more cleat cavity 2250 configured to receive a respective ground surface traction element 17 of sole plate 16.

In a molding process, spring base elements 2226, 2228, 2230, 2232, 2234 of serpentine spring member 2216 may be disposed in respective spring base cavities 2236, 2238, 2240, 2242, 2244 and a sheet of molding material 2252 may be disposed between lower mold plate 2210 and upper mold plate 2212 in registration with lower sole plate recess 2215 and upper sole plate recess 2246. In some embodiments, a sheet of molding material 2252 may be pre-formed or pre-cut to form a molding material blank (indicated in phantom with dashed lines in FIG. 22). In some embodiments, a sheet of molding material 2252 may include at least one wear surface treated area 2254 corresponding to a reactive spring element 2218, 2220, 2222, 2224 of serpentine spring member 2016. In some embodiments, a wear surface treated area may be an area of the sheet of molding material treated to improve a wear characteristic of the material. In some embodiments, at least one external wear surface material blank 2256 and/or at least one internal wear surface material blank 2258 optionally may be disposed in the molding system in registration with a respective reactive spring element 2218, 2220, 2222, 2224. As shown in FIG. 22, in a molding process molding system 2200 may be closed to perform a compression and/or thermal molding process. In some embodiments, vacuum system 2214 optionally may be used to draw molding material 2252 into spring cavity 2248 and/or cleat cavities 2250 in upper mold plate 2212. Upon molding, the sheet of molding material 2252 may bond or mold to sole plate 16. In some embodiments, a perimeter of molding material 2252 may bond or mold to a perimeter of sole plate 16, to form a web 42 of ground surface material accumulation prevention structure 12. In some embodiments, a portion of molding material 2252 may bond to a portion of lower surface 32 of sole 16, e.g., to a base portion of a ground surface traction element 17, to facilitate prevention of ground surface material entering into a gap formed at an interface between sole plate 16 and a web 42 of ground surface material accumulation prevention structure 12. In some embodiments, an exterior wear surface material blank 2256 and/or an interior wear surface material blank 2258 optionally may bond or mold to sheet molding material 2252, to improve a wear characteristic of a web 42 adjacent a spring element. Those skilled in the art readily will appreciate alternative molding processes suitable for molding a sole plate 16 having ground surface material accumulation prevention structure 12 according to the present invention.

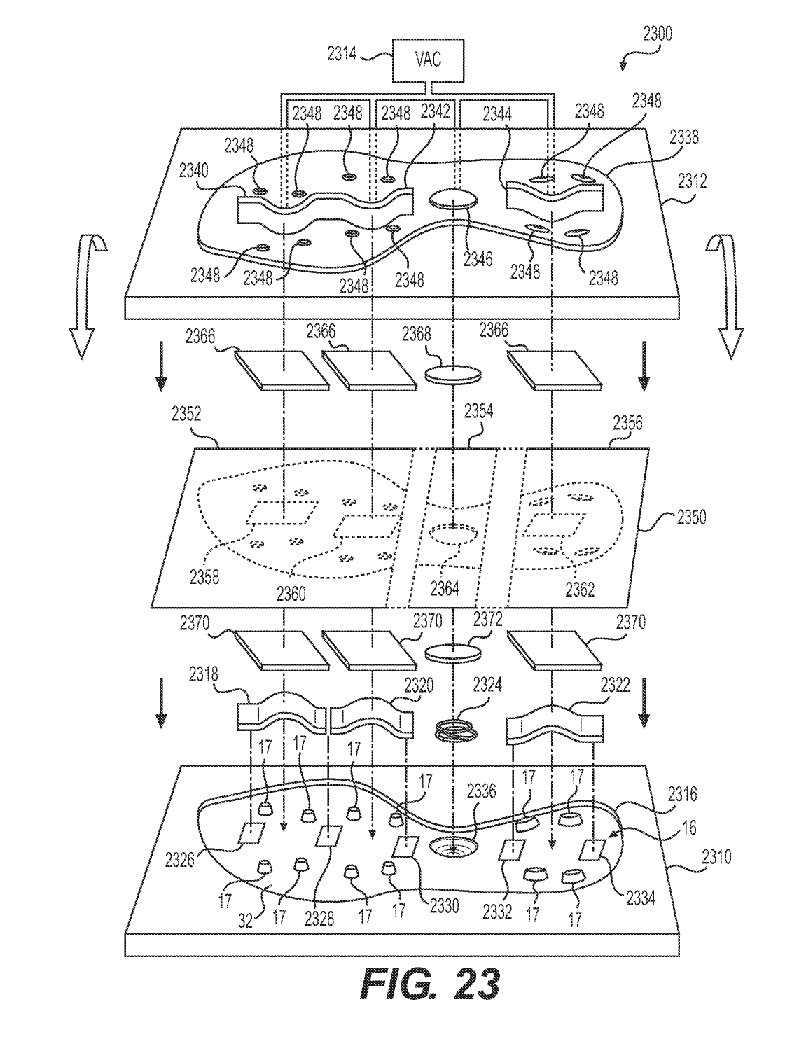

FIG. 23 illustrates an alternative embodiment of a molding system 2300 for molding a sole plate for an article of footwear, where the sole plate includes ground surface material accumulation prevention structure. As shown in FIG. 23, in some embodiments molding system 2300 and a molding process may be substantially similar to molding system 2000 and a molding process of FIG. 20 or molding system 2200 and a molding process of FIG. 22. Accordingly, this disclosure will describe differences in molding system 2300 and a molding process of FIG. 23.

FIG. 23 illustrates molding system 2300 in an exploded, open mold configuration. As shown in FIG. 23, in some embodiments molding system 2300 may include a lower mold plate 2310, an upper mold plate 2312, and an optional vacuum system 2314. In some embodiments, molding system 2300 may include additional components typically associated with a compression or thermal molding system, including components not described herein.

As shown in FIG. 23, in some embodiments sole plate 16 and molding system 23200 may be configured for molding a sole plate 16 having ground surface material accumulation prevention structure 12 selectively and variously including different types of spring elements, e.g., at least one leaf spring element and/or at least one coil spring element. As shown in FIG. 23, in some embodiments, a sole plate 16 may include a first leaf spring element 2318 located in a toe region 24, a second leaf spring element 2320 located in a ball of the foot region 26, a third leaf spring element 2222 located in a heel region 20, and a (fourth) coil spring element 2224 located in a midfoot region 22. Leaf spring elements 2318, 2320, 2322 may include spring base elements for locating and securing the leaf spring elements on sole plate 16. As shown in FIG. 23, in some embodiments, first leaf spring element 2018 may include a first spring base element located in the toe region 24 and a second spring base element located in the ball of the foot region 26; second leaf spring element 2320 may include a third spring base element located in the ball of foot region 26 and a fourth spring base element located in the midfoot region 22; third leaf spring element 2322 may include a fifth spring base element located in the midfoot region 22 and a sixth spring base element located in the heel region 20.

Lower sole plate 2210 may include a sole plate recess 2216 for receiving a sole plate 16 in a molding process. As shown in FIG. 23, in a molding process sole plate 16 may be disposed in sole plate recess 2216.

Sole plate 16 may include plural mold cavities for receiving plural spring elements of different types. As shown in FIG. 23, in some embodiments, sole plate 16 may include mold cavities for receiving and securing leaf spring elements 2318, 2320, 2322 and coil spring element 2324 thereon. As shown in FIG. 23, in some embodiments sole plate 16 may include a first spring base cavity 2326 located in toe region 24, a second spring base cavity 2328 located in ball of foot region 26, a third spring base cavity 2330 located in midfoot region 22, a fourth spring base cavity 2332 located in midfoot region 22, and a fifth spring base cavity 2334 located in heel region 20. Each spring base cavity may be sized and configured to receive and support a respective spring base element of leaf spring elements 2318, 2320, 2322. In some embodiments, sole plate 16 may include a coil spring cavity 2336 sized and configured to receive and support coil spring 2324. In a molding process, a spring base cavity or coil spring cavity may be configured to bond or mold a respective spring base element to the lower surface of sole plate 16.

Upper mold plate 2312 may be provided with mold cavities corresponding to features of sole plate 16, leaf spring elements 2318, 2320, 2322 and coil spring element 2324. As shown in FIG. 23, in some embodiments upper mold plate 2312 may include an upper sole plate recess 2338 sized and configured to receive a lower surface 32 of sole plate 16. As shown in FIG. 23, in some embodiments mold plate 2312 may include a first mold spring cavity 2340 sized and configured to receive leaf spring element 2318, a second mold spring cavity 2342 sized and configured to receive leaf spring element 2320, a third mold spring cavity 2346 sized and configured to receive coil spring element 2324, and a fourth mold spring cavity 2348 sized and configured to receive leaf spring element 2322. In some embodiments, mold plate 2312 may include one or more cleat cavity 2348 for receiving a respective ground surface traction element 17 of sole plate 16.

In a molding process, spring base elements of leaf spring elements 2318, 2320, 2322 may be disposed in respective spring base cavities 2326, 2328, 2330, 2332, 2334 and coil spring element 2324 may be disposed in spring recess 2336; and a sheet of molding material 2350 may be disposed between lower mold plate 2310 and upper mold plate 2312. In some embodiments, a sheet of molding material 2350 may be pre-molded or pre-cut to form one or more molding material blank (indicated in phantom with dashed lines in FIG. 23). In some embodiments, a sheet of molding material 2350 may include at least one wear surface treated area 2358, 2360, 2362, 2364 corresponding to a reactive leaf or coil spring element 2318, 2320, 2322, 2324. In some embodiments, a wear surface treated area may be an area of a sheet of molding material 2450 treated to improve a wear characteristic of the material. In some embodiments, at least one external wear surface material blank 2366 (leaf spring shape), 2368 (coil spring shape) and/or at least one internal wear surface material blank 2370 (leaf spring shape), 2372 (coil spring shape) optionally may be disposed in the molding system 2300 in registration with a respective leaf spring element 2218, 2220, 2222 or coil spring element 2224. As shown in FIG. 23, in a molding process molding system 2300 may be closed to perform a compression and/or thermal molding process. In some embodiments, vacuum system 2314 optionally may be used to draw molding material 2350 into a leaf spring mold cavity 2340, 2342, 2344, a coil spring mold cavity 2346, and/or cleat cavities 2348 in upper mold plate 2312.

In a molding process, a sheet of molding material 2350 may bond or mold to sole plate 16. In some embodiments, a sheet of molding material 2350 may bond or mold to a perimeter of sole plate 16, to form a web 42 of ground surface material accumulation prevention structure 12. In some embodiments, a perimeter of a sheet segment 2352, 2354, 2356 (or a corresponding sheet material molding material blank shown in phantom) may bond or mold to sole plate 16, to form a web 42 of a ground surface material accumulation prevention structure 12. In some embodiments, a portion of sheet of molding material 2350 may bond to a portion of lower surface 32 of sole 16, e.g., to a base portion of a ground surface traction element 17, to facilitate prevention of ground surface material entering into a gap formed at an interface between sole plate 16 and a web 42 of ground surface material accumulation prevention structure 12. In some embodiments, an exterior wear surface material blank 2366, 2368 and/or an interior wear surface material blank 2370, 2372 optionally may bond or mold to sheet molding material 2350, to improve a wear characteristic of a wear surface area of a web 42 adjacent a spring element. Those skilled in the art readily will appreciate alternative molding processes suitable for molding a sole plate 16 having ground surface material accumulation prevention structure 12 according to the present invention.

Functional Characteristics and Operation

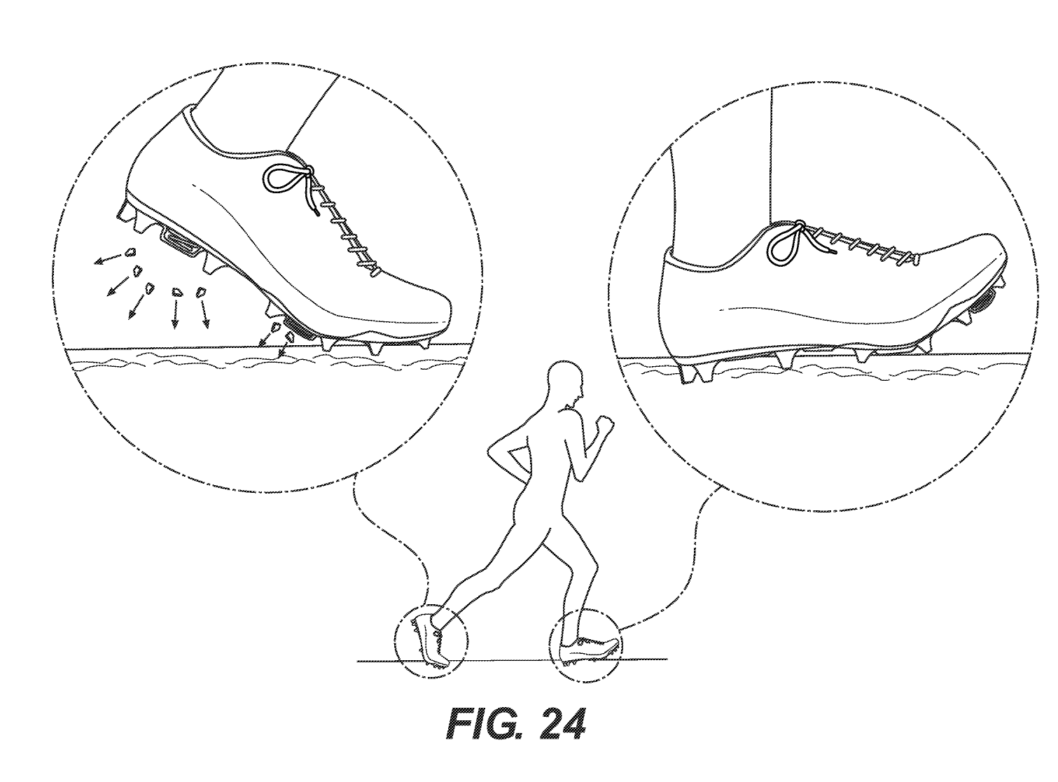

FIGS. 24 to 31 illustrate exemplary functional characteristics and operation of ground surface material accumulation prevention structures of the present invention. In these figures, ground surface material accumulation prevention structures operate to prevent accumulation of ground surface material on a lower surface of an article of footwear in active use of the article of footwear.

FIG. 24 is a schematic snap shot view of an athlete, illustrating functional characteristics and operation of a ground surface material accumulation prevention structure of the present invention in active use of an article of footwear. In FIG. 24, an athlete is shown in stride during normal athletic activity, such as running, playing soccer or another sport, etc., on a ground surface. The ground surface may include compactable ground surface material, such as mud, gravel, sand, clay, slush (snow, ice, or frost), etc., or various combinations thereof. In FIG. 24, the athlete's left foot is extended in front of the athlete's body in a heel strike state of a stride cycle, where a strike force and weight of the athlete is being transmitted to the ground surface. In this manner, a compression force between the sole 16 of the article of footwear 10 and the ground surface progressively is generated in the heel area 20 to the toe region 24 of the article of footwear 10. In FIG. 24, the athlete's right foot is extended in back of the athlete's body in a toe off state of a stride cycle, where a force and weight of the athlete generally is released. In this manner, a compression force between the sole 16 of the article of footwear 10 and the ground surface progressively is released from the heel area 20 to the toe region 24 of the article of footwear 10.

In FIG. 24, the heel strike state is shown in enlarged view in the upper right hand portion of the figure, and the toe off state is shown in enlarged view in the upper left hand portion of the figure. Although functional characteristics and operation of the ground surface material accumulation prevention structure 12 are shown in FIG. 24 with respect to a stride cycle including heel strike and toe off states, this stride cycle is exemplary only to illustrate different functional characteristics and operation states of ground surface material accumulation prevention structure 12 in active use of the article of footwear. Those skilled in the art readily will appreciate that the ground surface material accumulation prevention structure 12 may be used with similar functional characteristics and operation in other stride cycles, such as running on the ball of the feet or running with a lateral midfoot strike cycle.

In the exemplary stride cycle shown in FIG. 24, a first article of footwear (left shoe) 10 is shown with three ground surface material accumulation prevention structures 12 in three different operation states associated with a heel strike state of the stride cycle. A first ground surface material accumulation prevention structure 12 located in the toe region 24 of the forefoot region 18 is shown in a fully non-compressed state, where the exposed surface of the web of the ground surface material accumulation prevention structure 12 is fully extended by the spring element. A second ground surface material accumulation prevention structure 12 located in the ball of the foot region 26 of the forefoot region 18 is shown in a partially compressed state, where the spring element and exposed surface of the web of the ground surface material accumulation prevention structure 12 are partially collapsed. A third ground surface material accumulation prevention structure 12 located in the heel region 20 is shown in a fully compressed state, where the spring element and exposed surface of the web of the ground surface material accumulation prevention structure 12 are fully collapsed to lay substantially proximal the lower surface of the sole of the article of footwear.

In the exemplary stride cycle shown in FIG. 24, a second article of footwear (right shoe) 10 is shown with three ground surface material accumulation prevention structures 12 in three different operation states associated with a toe off state of the stride cycle. A first ground surface material accumulation prevention structure 12 located in the toe region 24 of the forefoot region 18 is shown in a fully compressed state, where the spring element and exposed surface of the web of the ground surface material accumulation prevention structure 12 are fully collapsed to lay substantially flat proximal the lower surface of the sole of the article of footwear. In this state, a thrust force and weight of the athlete is being transferred to the ground surface. A second ground surface material accumulation prevention structure 12 located in the ball of the foot region 26 of the forefoot region 18 is shown in a partially compressed state, where the spring element and exposed surface of the web of the ground surface material accumulation prevention structure 12 is partially collapsed (partially released). And a third ground surface material accumulation prevention structure 12 located in the heel region 20 is shown in a fully non-compressed state (fully released state), where the spring element and exposed surface of the web of the ground surface material accumulation prevention structure 12 are fully extended.

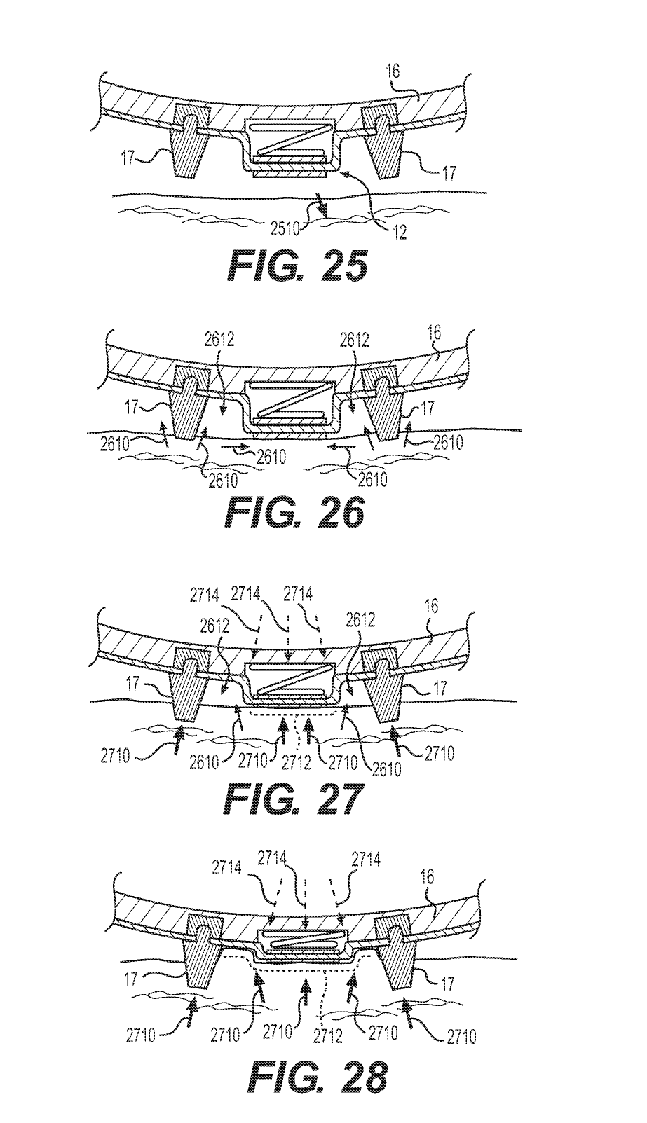

FIGS. 25 to 31 illustrate functional characteristics and operation of a single ground surface material accumulation prevention structure with respect to compression forces progressively generated and released between the article of footwear and the ground surface, to prevent accumulation of ground surface material on the lower surface of the article of footwear in active use of the article of footwear. In FIGS. 25-31 an exemplary ground surface material accumulation prevention structure is shown in sectional view to illustrate physical deformation associated with external compression forces applied to, and internal reactive spring forces generated by, a reactive spring element of the ground surface material accumulation prevention structure.

FIG. 25 is a schematic sectional view of a ground surface material accumulation prevention structure illustrating a pre-surface strike state in an operation cycle of the structure. In this state the article of footwear and ground surface material accumulation prevention structure may be descending toward the ground surface, as indicated by arrow 2510. As shown in FIG. 25, in this state the spring element 44 and exposed wear surface treated area of the ground surface material accumulation prevention structure 12 is fully non-compressed and extended.

FIG. 26 is a sectional view of a ground surface material accumulation prevention structure illustrating an initial surface strike state in an operation cycle of the structure. In the initial surface strike state of FIG. 26, one or more ground surface traction elements 17 may contact the ground surface in advance of the ground surface material accumulation prevention structure 12, which may be disposed above the ground surface and is fully extended. In this state, the ground surface traction elements 17 may begin to displace ground surface material, as indicated by small solid arrows 2610. In this manner, a portion of ground surface material may be displaced into a space 2612 located under the ground surface material accumulation prevention structure 12 and between the ground surface material accumulation prevention structures 17. Those skilled in the art readily will appreciate that the ground surface material, including displaced ground surface material, may begin to compact.

FIG. 27 is a schematic sectional view of a ground surface material accumulation prevention structure illustrating a partial ground penetration state in an operation cycle of the structure. In the partial ground penetration state of FIG. 27, the lower surface 32 and sole 16 of the article of footwear 10 begin to engage the ground surface with a compression force, as indicated by thick solid arrows 2710. A source of the compression force may include various factors, such as a force of weight of the athlete, a heel strike force, a thrust force (e.g., from an athlete changing a direction of stride), a toe off push, and the like. Ground surface material located below the ground surface material accumulation structure 12, including ground surface material displaced by a penetrating ground surface traction element 17, may be compacted under the ground surface material accumulation prevention structure 12 by the compression force 2710. In this manner the compression force 2710 may begin to create a layer of compacted surface material (indicated by dashed line) 2712 disposed on the exposed surface of the ground surface material accumulation prevention structure 12.

In the partial ground penetration state illustrated in FIG. 27 the exposed surface of the web 42 of the ground surface material accumulation prevention structure 12 begins to deform by compression. In this manner, a portion of energy generated by the compression force 2710 is absorbed by the reactive spring element 44 of the ground surface material accumulation prevention structure 12; this absorbed energy may be expressed as a reactive force generated in the reactive spring element 44 that is biased to return the exposed surface of the web 42 to a fully extended state, as indicated by dashed arrows 2714. The reactive force generated by compression of the reactive spring element 44 is small relative to the compression force 2710 between the sole 16 and the ground surface, as indicated in FIG. 27 by the relative thickness of compression force arrows 2710 and reactive spring force arrows 2714. The reactive spring force 2714 generated by the energy absorbed by the reactive spring element 44 need only be sufficient to return the exposed surface of the web 42 to the fully extended state upon release of the compression force 2710, as discussed below. In this manner, energy of the athlete corresponding to the compression force 2710 is substantially transferred to the ground surface, with a portion of the energy being transferred to reactive spring element 44 of the ground surface material accumulation prevention structure 12.

FIG. 28 is a schematic sectional view of a ground surface material accumulation prevention structure illustrating a full ground penetration state in the operation cycle of the structure. In the full ground penetration state of FIG. 28, the compression force 2710 at the ground surface material accumulation prevention structure 12 may be at a maximum, with maximum transmission of energy from the athlete to the ground surface. As shown in the full ground surface penetration state of FIG. 28, the compression force 2710 may be exerted across an entire surface area of the ground surface material accumulation prevention structure 12. As shown in FIG. 28, the compression force 2710 may be substantially greater than the reaction spring force 2714 absorbed and stored in reaction spring element 44 of ground surface material accumulation prevention structure 12. As shown in FIG. 28, in the full ground penetration state the layer of compacted ground surface material (indicated by dashed line) 2712 may be formed on the exposed surface of the web 42 of the ground surface material accumulation prevention structure 12.

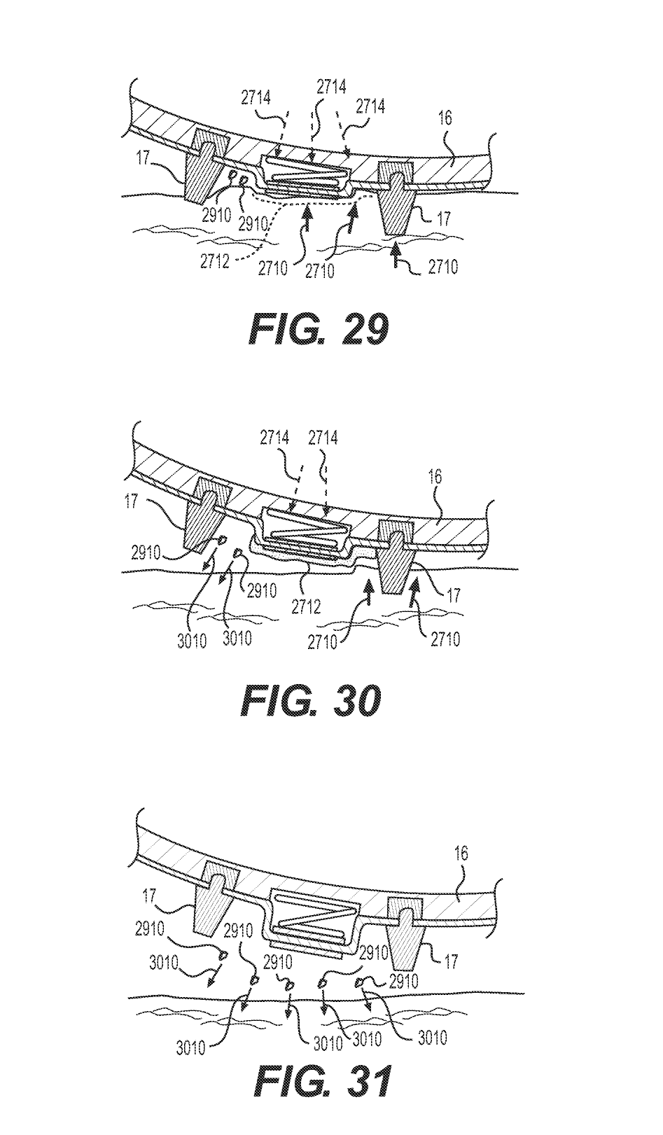

FIG. 29 is a schematic sectional view of a ground surface material accumulation prevention structure illustrating an initial release state in an operation cycle of the structure. As shown in FIG. 29, in the initial release state sole 16 of the article of footwear may begin to lift off from the ground surface. As sole 16 begins to lift off from the ground surface, the layer of compacted ground surface material 2712 may begin to separate from the ground surface proper and become exposed, and a localized compaction force 2710 may begin to release. As the layer of compacted ground surface material 2712 becomes exposed and the localized compaction force 2710 is released, a portion of the reactive energy absorbed and stored in the reactive spring element 44, expressed as reactive spring force 2714, may begin to expand a portion of the exposed surface of the web 42 to begin to return the reactive spring element 44 and a portion of the exposed surface of the web 44 to an extended, non-compressed state. In some embodiments the surface of the web 42 may begin to move relative to the layer of compacted ground surface material 2712 and generate surface tension forces. In some embodiments the surface of the web 42 may twist or shift to a new orientation relative to the layer of compacted ground surface material 2712. In this manner, expansion of the spring element 44 and portion of the surface of the web 42 may cause the layer of compacted ground surface material 2712 to begin to break apart into particles of ground surface material 2910.

FIG. 30 is a schematic sectional view of a ground surface material accumulation prevention structure illustrating a substantial release state in an operation cycle of the structure. As shown in FIG. 30, in the substantial release state sole 16 continues to lift off from the ground surface proper. In this state a compression force 2710 may continue to be applied between the ground surface and at least one ground surface traction element 17. In this state, reactive energy absorbed and stored in the reactive spring element 44 may continue to be expressed as a reactive force 2714 at the reactive spring element 44 and surface of web 42 to expand the spring element 44 and surface of web 42 toward a fully non-compressed state. Continued expansion of the spring element 44 and surface of the web 42 may continue to break apart the layer of compressed ground surface material 2714 into particles of ground surface material 2910. In some embodiments, in response to release of the compression force 2910, the reactive spring element may ‘pop’ the surface of the web 42 to a substantially expanded, non-compressed state (e.g., to a fully expanded state). In this manner, reactive spring energy absorbed and stored in the reactive spring element 44 may be transferred to the particles of ground material 2910 to expel particles of ground surface material 2910 from the surface of web 42, as indicated by arrows 3010.

FIG. 31 is a schematic sectional view of a ground surface material accumulation prevention structure illustrating a full release state in an operation cycle of the structure. In the full release state, the reactive spring element 44 and surface of the web 42 are fully extended, and the reactive spring energy absorbed and stored in the reactive spring element 44 from the compression force 2710 may be fully transferred from the reactive spring element 44 to particles of ground surface material 2910, as indicated by arrows 3010. In this manner, ground surface material may be prevented from accumulating on the lower surface 32 and sole 16 of the article of footwear 10 in active use of the article of footwear 10.

As discussed above, a ground surface material accumulation prevention structure of the present invention may operate to prevent onset of accumulation of ground surface material on a lower surface and sole of an article of footwear in active use of the article of footwear. As illustrated in FIGS. 24-31, in some embodiments a ground surface material accumulation prevention structure may operate in association with a heel strike to toe off stride cycle in active use of the article of footwear. In some embodiments, a ground surface material accumulation prevention structure may operate in association with other active use of an article of footwear. Non-exhaustive examples include playing sports such as soccer, football, lacrosse, etc., as well as activities in snow, ice, and slush. Those skilled in the art readily will appreciate alternative active use of an article of footwear suitable for a ground surface material accumulation prevention structure of the present invention.

As discussed above, a ground surface material accumulation prevention structure of the present invention may operate to prevent accumulation of ground surface material by moving a spring element and exposed surface of a web of the structure between a first position and a second position in response to a compression force applied to the reactive spring element in active use of the article of footwear. In some embodiments, a reactive spring element may move an exposed surface of the web between a first state and a second state relative to the lower surface of the article of footwear, e.g., relative to one or more ground surface traction elements on the lower surface and sole of the article of footwear. In some embodiments, a reactive spring element may move an exposed surface of the web between a first orientation and a second orientation relative to the lower surface and sole of the article of footwear, e.g., to twist relative to one or more ground surface traction elements on the lower surface and sole of the article of footwear. In some embodiments, a reactive spring element may move an exposed surface of the web between a first surface contour and a second surface contour different from the first surface contour. In some embodiments, a reactive spring element may move an exposed surface of the web between a first position proximate the lower surface of the sole of the article of footwear and a second position further away from the lower surface of the sole of the article of footwear. In each case a reactive spring element may be configured to move an surface of the web relative to a layer of compacted ground surface material being formed by the compression force adjacent the surface of the web in active use of the article of footwear, to facilitate breaking up the layer of compacted ground surface material into particles of ground surface material and discarding of the compacted ground surface material from the lower surface of the article of footwear in the active use of the article of footwear.

Functional, operational, and performance characteristics of a ground surface material accumulation prevention structure may be controlled by selecting materials and dimensional characteristics of the reactive element of the structure. A reactive force characteristic of the reactive element may be determined by controlling various factors, including a material composition of the reactive element, a thickness of the exposed surface of a dome-shaped reactive element, a depth of the dome shaped reactive element, a size of the reactive element (e.g., radius or length and width). Those skilled in the art readily will be able to determine a material composition, size, and configuration of a reactive element for achieving desired functional, operational, and performance characteristics in a ground surface material accumulation prevention structure.

Those skilled in the art readily will appreciate that each of the embodiments shown in FIGS. 1-31 may have one or more advantages in a particular application. In some applications, one embodiment may have a more desired performance characteristic, such as providing a desired reactive spring force characteristic, providing a desired traction characteristic for a selected playing surface, or providing a desired safety characteristic. In some embodiments, one embodiment may have a more desired aesthetic characteristic than another embodiment. Those skilled in the art readily will be able to select an appropriate configuration for a desired application.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

1. An article of footwear comprising:
a sole having a lower surface;
a web that covers a portion of the lower surface of the sole, the web having an exposed surface and a through-hole;
a first ground surface traction element disposed within the through-hole such that the web is secured between the first ground surface traction element and the lower surface of the sole; and
a spring disposed between the lower surface of the sole and the web, the spring being configured to transition a portion of the exposed surface of the web between a first state and a second state in response to a compression force generated between the spring and an external ground surface by user activity, to prevent accumulation of ground surface material compacting on the sole of the article of footwear by the user activity.

2. The article of footwear according to claim 1, wherein the spring is configured to move the portion of the exposed surface of the web to a first position adjacent the lower surface of the sole in response to the compression force and to a second position located further from the lower surface of the sole than the first position in response to release of the compression force.

3. The article of footwear according to claim 1, wherein the lower surface of the sole includes a second ground surface traction element, wherein the spring is disposed between the first ground surface traction element and the second ground surface element, wherein the spring is optionally fixed to the lower surface of the sole.

4. The article of footwear according to claim 1, wherein the spring is a coil spring or a leaf spring.

5. The article of footwear according to claim 1, wherein the web is made of an elastomeric material.

6. The article of footwear according to claim 1, wherein the web includes a wear resistant surface treated on at least one of (a) a portion of the web that contacts the spring and (b) a portion of the exposed surface of the web corresponding to a location of the spring.

7. The article of footwear according to claim 1, wherein a perimeter portion of the web is fixed to the sole.

8. The article of footwear according to claim 1, wherein a perimeter portion of the web is bonded to the sole.

9. The article of footwear according to claim 1, wherein a perimeter portion of the web is molded to the sole.

10. The article of footwear according to claim 1, wherein the article of footwear further comprises an upper, and a perimeter portion of the web is fixed to the upper, wherein the perimeter portion of the web is optionally fixed to the upper at a perimeter of the sole.

11. The article of footwear according to claim 1, wherein a contour of the web conforms to a contour of the lower surface of the sole and the contour of the web is pre-formed by molding.

12. The article of footwear according to claim 1, wherein the spring includes a first spring disposed between a first cluster of ground surface traction elements and the article of footwear includes a second spring disposed between a second cluster of ground surface traction elements, the first spring having a first spring constant k1, and the second spring constant having a second spring constant k2, wherein the first spring constant k1 is optionally different from the second spring constant k2.

13. The article of footwear according to claim 1, wherein the spring is a leaf spring having a first spring element disposed between a first cluster of ground surface traction elements and a second spring element disposed between a second cluster of ground surface traction elements, the first spring element having a first spring constant k1, and the second spring element having a second spring constant k2.

14. The article of footwear according to claim 1, wherein a contour of the web conforms to a contour of at least one of the ground surface traction elements of the first cluster or the second cluster.

15. The article of footwear according to claim 1, wherein the article of footwear further comprises a clip configured to attach to the at least one ground surface traction element with the web disposed between the clip and the at least one ground surface traction element, wherein the clip optionally forms a band configured to conform to a perimeter surface portion of the at least one ground surface traction element.

16. The article of footwear according to claim 1, wherein the spring includes a first spring disposed between a first cluster of ground surface traction elements and the article of footwear includes a second spring disposed between a second cluster of ground surface traction elements, the first spring having a first size, and the second spring having a second size different from the first size.

17. A method of making an article of footwear comprising:
providing a sole having a lower surface;
providing a web that covers a portion of the lower surface of the sole, the web having an exposed surface and a through-hole;
extending a portion of a ground surface traction element through the through-hole such that the web is secured between the ground surface traction element and the lower surface of the sole; and
placing a spring between the lower surface of the sole and the web, the spring being configured to transition a portion of the exposed surface of the web between a first state and a second state in response to a compression force generated between the spring and an external ground surface by user activity, to prevent accumulation of ground surface material compacting on the sole of the article of footwear by the user activity.

18. The method of making an article of footwear according to claim 17, further comprising:
providing a molding system having:
a first mold plate including a first mold cavity; and
a second mold plate including a second mold cavity;
placing a mold material blank in between the first mold plate and the second mold plate in a position adjacent to the first mold cavity;
placing the sole plate in between the mold material blank and the second mold plate such that the sole plate is disposed within the second mold cavity;
positioning the spring element;
pressing the first mold plate and the second mold plate together; and
applying heat to both the first mold plate and the second mold plate to mold the mold material blank to the lower surface of the sole plate such that the spring element is disposed between the mold material blank and the lower surface of the sole plate.

19. The method of making an article of footwear according to claim 17, further comprising suctioning air from both the first mold cavity and the second mold cavity.

20. The method of making an article of footwear according to claim 17, further comprising:
forming the mold material blank by cutting a sheet of mold material to have a perimeter that conforms with a perimeter of the sole plate.
